(19) United States
(12) Patent Application Publication
(10) Pub. No.: US 2025/0143362 A1
(43) Pub. Date: May 8, 2025

(54) COLLOIDAL FOOD BASE COMPOSITIONS COMPRISING MYCELIAL BIOMASS

(71) Applicant: THE FYNDER GROUP, INC, Chicago, IL (US)

(72) Inventors: Alexander Plotkin, Chicago, IL (US); Eleanore Brophy Eckstrom, Chicago, IL (US); Chelsey Hinnincamp, Chicago, IL (US); Hannah Fenton, Chicago, IL (US)

(21) Appl. No.: 18/949,453

(22) Filed: Nov. 15, 2024

Related U.S. Application Data
(63) Continuation of application No. PCT/US24/54250, filed on Nov. 1, 2024.
(60) Provisional application No. 63/596,093, filed on Nov. 3, 2023.

(51) Int. Cl. A23L 31/10; A23L 9/20; A23L 23/00; A23L 35/00

(52) U.S. Cl. CPC A23L 31/10; A23L 9/24; A23L 23/00; A23L 35/10

(57) ABSTRACT

Colloidal food base compositions comprising fungal mycelial biomass are disclosed, as are methods of making such colloidal food base compositions. The fungal mycelial biomass may stabilize the colloid and/or act as a supplemental or replacement source of protein in analogs of conventional non-fungal colloidal food products, such as ice cream and mayonnaise.

### CROSS REFERENCE TO RELATED APPLICATIONS

This application is a continuation of Patent Cooperation Treaty (PCT) application PCT/US2024/054250, filed 1 Nov. 2024, which designates the United States and which claims priority to U.S. provisional patent application 63/596,093, filed 3 Nov. 2023. Both of the above-referenced applications are incorporated herein by reference in their entireties.

### FIELD

This application relates to edible filamentous fungi and provides methods of preparing colloidal suspensions of edible filamentous fungi, particularly colloidal food base compositions containing edible filamentous fungi and colloidal food products comprising fungal mycelial biomass, as well as uses and methods associated therewith.

### BACKGROUND

Many popular food ingredients and products are mixtures in which particles of one substance (a “dispersed phase”) are dispersed throughout a volume of a different substance (a “dispersion medium” or “dispersion phase”); mixtures of this type are referred to herein as “colloidal” or “colloids.” Examples of colloidal foods include blancmange, bread, butter, cake, custard, egg white foam, ice cream, jam, jelly, margarine, mayonnaise, meringue, milk, whipped cream, and many sauces and spreads (e.g., béchamel sauce, espagnole sauce, hollandaise sauce, hummus, Russian dressing, tartar sauce, Thousand Island dressing, velouté sauce, etc.). As the preceding list of examples illustrates, however, many colloidal foods are “indulgence” items—foods that may be particularly rich or decadent, and that can therefore be expensive or unhealthy if consumed regularly or in large quantities. Moreover, many such colloids include at least one phase of an allergenic substance and/or a substance that is derived or obtained from animals and may therefore be unsuitable for consumption by vegans or other persons with dietary restrictions or allergic sensitivities; existing hypoallergenic or vegan alternatives to conventional colloidal food products often suffer from poor stability and rapid separation of the colloidal phases.

Additionally, in large-scale food service operations (restaurants, hotels, etc.), the timely formulation of colloidal food products in commercial quantities with consistent quality can be a considerable challenge. Depending on ingredients, formation of stable colloids can be time-, labor-, and/or energy-intensive, which may result in unacceptable delays in service or degradation in food product quality, particularly where a particular recipe or other production process may call for combining a previously formed colloid with additional ingredients.

Culinary cream (also referred to as culinary cream base or cuisine cream) is a conventional colloidal food base that serves as a base ingredient for soups, sauces, and other creamy food items (e.g., dressings, condiments, batters, custards, etc.) to add creamy texture and to bind and stabilize ingredients, preventing breaking into an aqueous phase and an oil or fat phase. Culinary creams are dairy-based products and typically contain milk and/or butter. As such, typical culinary creams pose a problem for individuals with milk allergies. Moreover, most culinary creams have low or no protein and fiber while containing significant amounts of saturated fat.

There is thus a need in the art for colloidal food base compositions, including but not limited to culinary creams or culinary cream substitutes, that can be combined with other ingredients to form colloidal food products that are analogous in taste, texture, and other aesthetic and sensory characteristics to conventional colloidal food products, but that can be provided at low cost and/or with an improved nutritional profile. It is advantageous for such colloidal food products to be non-dairy and/or free of allergenic or animal-derived products to allow these products to appeal to a wider range of potential consumers, and to remain stable and/or homogeneous over extended periods to provide for a longer usable shelf life. It is further advantageous for such food base compositions to be amenable to long-term storage and/or transportation; to be stable as a colloid over a wide range of water: lipid ratios, such that aqueous or fatty ingredients can be added to the food base compositions without compromising the colloidal stability thereof; to remain stable and avoid separation at high temperatures, low temperatures, and/or acidic pHs; to effectively replace milk or buttermilk in creamy food products and batters (e.g., batters for waffles, buns, and other baked goods); and, in some cases, to be characterized by a mild and/or neutral aroma, color, flavor, etc. to allow for the creation of many different colloidal food products from a single food base composition. It is additionally advantageous for such colloidal food products to maintain a white or neutral color without browning, yellowing, or developing other off-colors when heated, cooled, or exposed to acidic pH so as to be incorporated into food products without imparting an undesirable or negative color to the food product.

### SUMMARY

In an aspect of the present disclosure, a food base composition comprises fungal mycelial biomass, wherein a dry weight of the fungal mycelial biomass is about 2 wt % to about 15 wt % of the food base composition; an aqueous liquid, in an amount of about 20 wt % to about 80 wt %; and one or more edible fats or oils, in an amount of about 10 wt % to about 80 wt %.

In embodiments, the food base composition may consist essentially of the fungal mycelial biomass, the aqueous liquid, and the one or more edible fats or oils.

In embodiments, the food base composition may further comprise a thickener. The thickener may, but need not, be selected from the group consisting of oxystearin, alginic acid, sodium alginate, potassium alginate, ammonium alginate, calcium alginate, propane-1,2-diol alginate, agar, carrageenan, processed Eucheuma seaweed, locust bean gum, oat gum, guar gum, tragacanth, acacia gum, xanthan gum, karaya gum, tara gum, gellan gum, gum ghatti, polyoxyethene (8) stearate, aspartame-acesulfame salt, maltitol, amylase, proteases, invertase, polydextrose, polyvinylpyrrolidone, polyvinylpolypyrrolidone, dextrin, modified starch, alkaline modified starch, bleached starch, monostarch phosphate, distarch phosphate esterified with sodium trimetaphosphate or phosphorus oxychloride, phosphated distarch phosphate, starch acetate esterified with acetic anhydride, starch acetate acetified with vinyl acetate, acetylated distarch adipate, distarch glycerine, hydroxy propyl distarch glycerine, hydroxy propyl distarch phosphate, starch sodium octenyl succinate, triethyl citrate, oxidized starch, distarch glycerol, acetylated distarch phosphate, acetylated distarch glycerol, hydroxy propyl starch, citrus fiber, guar-xanthan blends, hydroxyethyl cellulose, and combinations thereof.

In embodiments, the fungal mycelial biomass may be produced by a process selected from a submerged fermentation, a surface fermentation, a submerged solid substrate fermentation, a solid substrate fermentation, a membrane fermentation, an air-medium colloid fermentation, and combinations thereof. The surface fermentation may, but need not, be liquid surface fermentation. The fungal mycelial biomass may, but need not, be produced by a submerged fermentation and may, but need not, be in the form of a flour or paste. The fungal mycelial biomass may, but need not, be a cohesive mycelial biomass.

In embodiments, the food base composition may be non-dairy. The food base composition may, but need not, be vegan.

In embodiments, at least one of the following may be true: (i) the food base composition comprises no more than about 450 mg of saturated fat per 15 mL (1 tablespoon) of the food base composition; (ii) the food base composition comprises at least about 150 mg of protein per 15 mL (1 tablespoon) of the food base composition; (iii) the food base composition comprises at least about 150 mg of dietary fiber per 15 mL (1 tablespoon) of the food base composition; and (iv) the food base composition has a food energy content of no more than about 35 kcal per 15 mL (1 tablespoon) of the food base composition.

In embodiments, the food base composition may have an L* color value of at least about 70.

In embodiments, a pH of the food base composition may be about 5.5 to about 6.5.

In embodiments, the fungal mycelial biomass may, or may not, comprise fungal fruiting bodies or portions thereof.

In embodiments, fungal mycelium may make up at least about 55 wt %, at least about 60 wt %, at least about 65 wt %, at least about 70 wt %, at least about 75 wt %, at least about 80 wt %, at least about 85 wt %, at least about 90 wt %, at least about 95 wt %, at least about 96 wt %, at least about 97 wt %, at least about 98 wt %, at least about 99 wt %, or substantially all of the fungal mycelial biomass.

In embodiments, the fungal mycelial biomass may comprise at least about 27 wt % dietary fiber.

In embodiments, the fungal mycelial biomass may comprise no more than about 37 wt % dietary fiber.

In embodiments, the fungal mycelial biomass may comprise at least about 30 wt % protein.

In embodiments, the fungal mycelial biomass may comprise no more than about 80 wt % protein.

In embodiments, the fungal mycelial biomass may comprise all nine essential amino acids. The fungal mycelial biomass may, but need not, comprise all twenty proteinogenic amino acids.

In embodiments, the food base composition may comprise between about 1 wt % to about 10 wt % protein.

In embodiments, the food base composition may comprise between about 0.25 wt % to about 8.0 wt % dietary fiber.

In embodiments, the food base composition may be non-dairy. The food base composition may, but need not, be vegan.

In embodiments, the food base composition may be hypoallergenic.

In embodiments, the fungal mycelial biomass may comprise at least about 10 wt %, at least about 15 wt %, at least about 20 wt %, at least about 25 wt %, or at least about 30 wt % branched-chain amino acids.

In embodiments, the food base composition may further comprise at least one protein not derived from animals or fungi. The at least one protein not derived from animals or fungi may, but need not, be derived from one or more plants or algae.

In embodiments, the aqueous liquid and the one or more edible fats or oils may remain substantially homogenously mixed, and/or may not visibly separate, for at least about one day, at least about two days, at least about three days, at least about four days, at least about five days, at least about six days, at least about one week, at least about two weeks, at least about three weeks, at least about one month, at least about two months, at least about three months, at least about four months, at least about five months, at least about six months, at least about seven months, at least about eight months, at least about nine months, at least about ten months, at least about eleven months, at least about twelve months, at least about thirteen months, at least about fourteen months, at least about fifteen months, at least about sixteen months, at least about seventeen months, or at least about eighteen months after formation of the food base composition.

In embodiments, the food base composition may be configured such that the aqueous liquid and the one or more edible fats or oils can remain substantially homogenously mixed, and/or do not visibly separate, when the food base composition is contacted with an additional quantity of aqueous liquid.

In embodiments, the food base composition may be configured such that the aqueous liquid and the one or more edible fats or oils can remain substantially homogenously mixed, and/or do not visibly separate, when the food base composition is contacted with an additional quantity of edible fats or oils.

In embodiments, the food base composition may be configured such that the aqueous liquid and the one or more edible fats or oils can remain substantially homogenously mixed, and/or do not visibly separate, when subjected to an acidic condition, a heat condition, a cold condition, or combinations thereof. The acidic condition may, but need not, be a pH of 6.5 or lower. The heat condition may, but need not, be a temperature of 35° C. or higher. The cold condition may, but need not, be a temperature of 4° C. or lower.

In embodiments, at least one alcohol may be miscible with, or very soluble, freely soluble, or soluble in, the food base composition.

In embodiments, at least one plant milk may be miscible with, or very soluble, freely soluble, or soluble in, the food base composition.

In another aspect of the present disclosure, a method for making a food base composition comprises contacting fungal mycelial biomass, an aqueous liquid, and one or more edible fats or oils to form a stable emulsion, gel, or sol.

In embodiments, the stable emulsion, gel, or sol may consist essentially of the fungal mycelial biomass, the aqueous liquid, and the one or more edible fats or oils.

In embodiments, the stable emulsion, gel, or sol may further comprise a thickener. The thickener may, but need not, be selected from the group consisting of oxystearin, alginic acid, sodium alginate, potassium alginate, ammonium alginate, calcium alginate, propane-1,2-diol alginate, agar, carrageenan, processed Eucheuma seaweed, locust bean gum, oat gum, guar gum, tragacanth, acacia gum, xanthan gum, karaya gum, tara gum, gellan gum, gum ghatti, polyoxyethene (8) stearate, aspartame-acesulfame salt, maltitol, amylase, proteases, invertase, polydextrose, polyvinylpyrrolidone, polyvinylpolypyrrolidone, dextrin, modified starch, alkaline modified starch, bleached starch, monostarch phosphate, distarch phosphate esterified with sodium trimetaphosphate or phosphorus oxychloride, phosphated distarch phosphate, starch acetate esterified with acetic anhydride, starch acetate acetified with vinyl acetate, acetylated distarch adipate, distarch glycerine, hydroxy propyl distarch glycerine, hydroxy propyl distarch phosphate, starch sodium octenyl succinate, triethyl citrate, oxidized starch, distarch glycerol, acetylated distarch phosphate, acetylated distarch glycerol, hydroxy propyl starch, citrus fiber, guar-xanthan blends, hydroxyethyl cellulose, and combinations thereof.

In embodiments, the fungal mycelial biomass may be produced by a process selected from a submerged fermentation, a surface fermentation, a submerged solid substrate fermentation, a solid substrate fermentation, a membrane fermentation, an air-medium colloid fermentation, and combinations thereof. The fungal mycelial biomass may, but need not, be produced by a submerged fermentation and may, but need not, be in the form of a flour or paste. The fungal mycelial biomass may, but need not, be a cohesive mycelial biomass.

In embodiments, the fungal mycelial biomass may, or may not, comprise fungal fruiting bodies or portions thereof.

In embodiments, fungal mycelium may make up at least about 55 wt %, at least about 60 wt %, at least about 65 wt %, at least about 70 wt %, at least about 75 wt %, at least about 80 wt %, at least about 85 wt %, at least about 90 wt %, or at least about 95 wt % of the fungal mycelial biomass.

In embodiments, the fungal mycelial biomass may comprise at least about 27 wt % dietary fiber.

In embodiments, the fungal mycelial biomass may comprise no more than about 37 wt %/dietary fiber.

In embodiments, the fungal mycelial biomass may comprise at least about 30 wt % protein.

In embodiments, the fungal mycelial biomass may comprise no more than about 80 wt % protein.

In embodiments, the fungal mycelial biomass may comprise all nine essential amino acids. The fungal mycelial biomass may, but need not, comprise all twenty proteinogenic amino acids.

In embodiments, the fungal mycelial biomass may comprise at least about 10 wt %, at least about 15 wt %, at least about 20 wt %, at least about 25 wt %, or at least about 30 wt % branched-chain amino acids.

In embodiments, the method may further comprise contacting the stable emulsion, gel, or sol with at least one protein not derived from animals or fungi. The at least one protein not derived from animals or fungi may, but need not, be derived from one or more plants or algae.

In embodiments, the aqueous liquid and the one or more edible fats or oils may remain substantially homogenously mixed, and/or do not visibly separate, for at least about one day, at least about two days, at least about three days, at least about four days, at least about five days, at least about six days, at least about one week, at least about two weeks, at least about three weeks, at least about one month, at least about two months, at least about three months, at least about four months, at least about five months, at least about six months, at least about seven months, at least about eight months, at least about nine months, at least about ten months, at least about eleven months, at least about twelve months, at least about thirteen months, at least about fourteen months, at least about fifteen months, at least about sixteen months, at least about seventeen months, or at least about eighteen months after formation of the stable emulsion, gel, or sol.

In embodiments, the stable emulsion, gel, or sol may be configured such that the aqueous liquid and the one or more edible fats or oils can remain substantially homogenously mixed, and/or do not visibly separate, when the stable emulsion, gel, or sol is contacted with an additional quantity of aqueous liquid.

In embodiments, the stable emulsion, gel, or sol may be configured such that the aqueous liquid and the one or more edible fats or oils can remain substantially homogenously mixed, and/or do not visibly separate, when the stable emulsion, gel, or sol is contacted with an additional quantity of edible fats or oils.

In embodiments, the method may further comprise mixing or dissolving at least one alcohol in the stable emulsion, gel, or sol.

In embodiments, the method may further comprise mixing or dissolving at least one plant milk in the stable emulsion, gel, or sol.

In another aspect of the present disclosure, a method for making a food product comprises contacting a food base composition as disclosed herein, or a food base composition made by a method as disclosed herein, with at least one food component.

In embodiments, the at least one food component may comprise a flavoring, an herb, a spice, a flavor enhancer, a fat, a fat replacer, a preservative, a sweetener, a color additive, a nutrient, an emulsifier, a stabilizer or thickener, a pH control agent, an acidulant, a leavening agent, an anti-caking agent, a humectant, a yeast nutrient, a dough strengthener or dough conditioner, a firming agent, an enzyme preparation, a gas, a vegetable, a fruit, a meat product, citrus fiber, or a combination thereof.

In embodiments, the at least one food component may comprise at least one flavoring selected from the group consisting of allyl hexanoate, benzyl acetate, bornyl acetate, butyl acetate, butyl butyrate, butyl propionate, ethyl acetate, ethyl benzoate, ethyl butyrate, ethyl hexanoate, ethyl cinnamate, ethyl formate, ethyl heptanoate, ethyl isovalerate, ethyl lactate, ethyl nonanoate, ethyl pentanoate, geranyl acetate, geranyl butyrate, geranyl pentanoate, isobutyl acetate, isobutyl formate, isoamyl acetate, isopropyl acetate, linalyl acetate, linalyl butyrate, linalyl formate, methyl acetate, methyl anthranilate, methyl benzoate, methyl butyrate, methyl cinnamate, methyl formate, methyl pentanoate, methyl phenylacetate, methyl salicylate, nonyl caprylate, octyl acetate, octyl butyrate, amyl acetate, pentyl butyrate, pentyl hexanoate, pentyl pentanoate, propyl acetate, propyl hexanoate, propyl isobutyrate, terpenyl butyrate, chocolate, cocoa, vanilla bean, vanilla extract, vanilla paste, or a combination thereof.

In embodiments, the at least one food component may comprise at least one herb selected from the group consisting of angelica, basil, bay leaf, Indian bay leaf, boldo, borage, chervil, chives, cicely, cilantro, cilantro, cress, curry leaf, dill, epazote, hemp, hoja santa, Houttuynia cordata, hyssop, jimbu, Elsholtzia ciliata, Perilla frutescens, lavender, lemon balm, lemon grass, lemon myrtle, lemon verbena, rice paddy herb, lovage, marjoram, mint, mugwort, mitsuba, oregano, parsley, perilla, rosemary, rue, sage, savory, Zanthoxlum piperitum, shiso, sorrel, tarragon, thyme, woodruff, or a combination thereof.

In embodiments, the at least one food component may comprise at least one spice selected from the group consisting of aonori, ajwain, alligator pepper, allspice, amchoor, anise, asafoetida, peppercorn, Brazilian pepper, camphor, caraway, cardamom, cassia, celery powder, celery seed, charoli, chenpi, chili pepper, cinnamon, clove, coriander seed, cubeb, cumin, deulkkae, dill, fennel, fenugreek, fingerroot, galangal, garlic, ginger, aromatic ginger, golpar, grains of paradise, grains of Selim, horseradish, Japanese pricklyash, juniper berry, kokum, korarima, dried lime, liquorice, Litsea cubeba, long pepper, mango-ginger, mastic, mahleb, mustard, nigella, njangsa, nutmeg, onion powder, paprika, Peruvian pepper, pomegranate seed, poppy seed, radhuni, rose, saffron, sarsaparilla, sassafras, sesame, shiso, Sichuan pepper, sumac, tamarind, Tasmanian pepper, tonka bean, turmeric, uzazi, vanilla, voatsiperifery, wasabi, zedoary, zereshk, citrus fruit zest, or a combination thereof.

In embodiments, the at least one food component may comprise at least one flavor enhancer selected from the group consisting of glutamic acid, monosodium glutamate, monopotassium glutamate, calcium diglutamate, monoammonium glutamate, magnesium diglutamate, guanylic acid, disodium guanylate, dipotassium guanylate, calcium guanylate, inosinic acid, disodium inosinate, dipotassium inosinate, calcium inosinate, calcium 5′-ribonucleotides, disodium 5′-ribonucleotides, maltol, ethyl maltol, glycine, sodium salt of glycine, zinc acetate, gum benzoic, thaumatin, glycyrrhizin, neohesperidine dihydrochalcone, amylase, proteases, or a combination thereof.

In embodiments, the at least one food component may comprise at least one preservative selected from the group consisting of rowanberry extract, sorbic acid, sodium sorbate, potassium sorbate, calcium sorbate, heptyl p-hydroxybenzoate, benzoic acid, sodium benzoate, potassium benzoate, calcium benzoate, ethylparaben, sodium ethyl para-hydroxybenzoate, propylparaben, sodium propyl para-hydroxybenzoate, methylparaben, sodium methyl para-hydroxybenzoate, sulfur dioxide, sodium sulfite, sodium bisulfite, sodium metabisulfite, potassium metabisulfite, potassium sulfite, calcium sulfite, calcium hydrogen sulfite, potassium hydrogen sulfite, biphenyl, orthophenyl phenol, sodium orthophenyl phenol, thiabendazole, nisin, natamycin, formic acid, sodium formate, calcium formate, hexamine, formaldehyde, dimethyl dicarbonate, potassium nitrite, sodium nitrite, sodium nitrate, potassium nitrate, acetic acid, potassium acetate, sodium acetates, calcium acetate, ammonium acetate, dehydroacetic acid, sodium dehydroacetate, lactic acid, propionic acid, sodium propionate, calcium propionate, potassium propionate, boric acid, sodium tetraborate, carbon dioxide, malic acid, fumaric acid, copper(II) sulfate, chlorine gas, chlorine dioxide, lysozyme, or a combination thereof.

In embodiments, the at least one food component may comprise at least one sweetener selected from the group consisting of sorbitol, mannitol, glycerol, acesulfame potassium, aspartame, cyclamate, isomalt, saccharin, sodium salts of saccharin, potassium salts of saccharin, calcium salts of saccharin, sucralose, alitame, thaumatin, glycyrrhizin, neohesperidine dihydrochalcone, steviol glycosides, neotame, aspartame-acesulfame salt, maltitol, lactitol, xylitol, erythritol, advantame, sucrose, cane sugar, fructose, honey, agave nectar, mogrosides, or a combination thereof.

In embodiments, the at least one food component may comprise at least one color additive selected from the group consisting of curcumin, riboflavin, riboflavin-5′-phosphate, tartrazine, alkannin, Quinoline Yellow WS, Fast Yellow AB, riboflavin-5′-sodium phosphate, Yellow 2G, sunset yellow FCF, Orange GGN, carmine, carminic acid, Citrus Red 2, carmoisine, amaranth, Ponceau 4R, Scarlet GN, Ponceau 6R, erythrosine, Red 2G, Allura Red AC, indanthrone blue, Patent Blue V, indigo carmine, brilliant blue FCF, chlorophylls, chlorophyllins, copper complexes of chlorophylls and chlorophyllins, Green S, fast green FCF, plain caramel, caustic sulfite caramel, ammonia caramel, sulfite ammonia caramel, Brilliant Black BN, carbon black, vegetable carbon, Brown FK, Brown HT, carotenes, annatto, bixin, norbixin, paprika oleoresin, lycopene, beta-apo-8′-carotenal, ethyl ester of beta-apo-8′-carotenal, flavoxanthin, lutein, cryptoxanthin, rubixanthin, violaxanthin, rhodoxanthin, canthaxanthin, zeaxanthin, citranaxanthin, astaxanthin, betanin, anthocyanins, saffron, calcium carbonate, titanium dioxide, iron oxides, iron hydroxides, aluminum, silver, gold, Lithol Rubine BK, tannins, orcein, or a combination thereof.

In embodiments, the at least one food component may comprise at least one nutrient selected from the group consisting of glucose, sucrose, ribose, amylose, amylopectin, maltose, galactose, fructose, lactose, alanine, arginine, aspartic acid, asparagine, cysteine, glutamic acid, glutamine, glycine, histidine, isoleucine, leucine, lysine, methionine, phenylalanine, proline, serine, threonine, tryptophan, tyrosine, valine, acetic acid, propionic acid, butyric acid, valeric acid, caproic acid, caprylic acid, lauric acid, myristic acid, pentadecanoic acid, palmitic acid, margaric acid, stearic acid, arachidic acid, behenic acid, lignoceric acid, cerotic acid, myristoleic acid, oleic acid, eicosenoic acid, erucic acid, nervonic acid, linoleic acid, alpha-linolenic acid, stearidonic acid, gamma-linolenic acid, arachidonic acid, eicosatetraenoic acid, timnodonic acid, clupanodonic acid, cervonic acid, calcium, sulfur, phosphorus, magnesium, sodium, potassium, iron, zinc, boron, copper, chromium, selenium, manganese, molybdenum, cobalt, fluorine, iodine, thiamin, riboflavin, niacin, pantothenic acid, pyridoxine, pyridoxal-5-phosphate, pyridoxamine, biotin, folate, cobalamin, choline, vitamin A, ascorbic acid, ergocalciferol, cholecalciferol, tocopherols, tocotrienols, phylloquinone, menaquinone, menadione, or a combination thereof.

In embodiments, the at least one food component may comprise at least one emulsifier selected from the group consisting of lecithin, metatartaric acid, calcium tartrate, alginic acid, sodium alginate, potassium alginate, ammonium alginate, calcium alginate, propane-1,2-diol alginate, carrageenan, processed Eucheuma seaweed, locust bean gum, tragacanth, acacia gum, karaya gum, gellan gum, gum ghatti, sorbitol, glycerol, konjac, polyoxyethene (8) stearate, polyoxyethene (40) stearate, polysorbate 20, polysorbate 80, polysorbate 40, polysorbate 60, polysorbate 65, pectins, gelatine, ammonium phosphatides, brominated vegetable oil, sucrose acetate isobutyrate, glycerol esters of wood rosins, diphosphates, triphosphates, polyphosphates, beta-cyclodextrin, cellulose, methyl cellulose, ethyl cellulose, hydroxypropyl cellulose, Hypromellose, ethyl methyl cellulose, carboxymethyl cellulose, sodium carboxymethyl cellulose, croscarmellose, enzymically hydrolyzed carboxymethylcellulose, sodium salts of fatty acids, potassium salts of fatty acids, calcium salts of fatty acids, magnesium salts of fatty acids, mono- and diglycerides of fatty acids, acetic acid esters of mono- and diglycerides of fatty acids, lactic acid esters of mono- and diglycerides of fatty acids, citric acid esters of mono- and diglycerides of fatty acids, tartaric acid esters of mono- and diglycerides of fatty acids, mono- and diacetyl tartaric acid esters of mono- and diglycerides of fatty acids, mixed acetic and tartaric acid esters of mono- and diglycerides of fatty acids, succinylated monoglycerides, sucrose esters of fatty acids, sucroglycerides, polyglycerol esters of fatty acids, polyglycerol polyricinoleate, propane-1,2-diol esters of fatty acids, propylene glycol esters of fatty acids, lactylated fatty acid esters of glycerol and propane-1, thermally oxidized soybean oil interacted with mono- and diglycerides of fatty acids, dioctyl sodium sulfosuccinate, sodium stearoyl-2-lactylate, calcium stearoyl-2-lactylate, stearyl tartrate, stearyl citrate, sodium stearoyl fumarate, calcium stearoyl fumarate, sodium laurylsulfate, ethoxylated mono- and diglycerides, methyl glucoside-coconut oil ester, sorbitan monostearate, sorbitan tristearate, sorbitan monolaurate, sorbitan monooleate, sorbitan monopalmitate, sorbitan trioleate, dicalcium diphosphate, sodium aluminum phosphate, calcium sodium polyphosphate, calcium polyphosphate, ammonium polyphosphate, magnesium stearate, calcium stearate, cholic acid, choline salts, oxidized starch, distarch glycerol, acetylated distarch phosphate, hydroxy propyl starch, starch sodium octenyl succinate, acetylated oxidized starch, or a combination thereof.

In embodiments, the at least one food component may comprise at least one stabilizer or thickener selected from the group consisting of oxystearin, alginic acid, sodium alginate, potassium alginate, ammonium alginate, calcium alginate, propane-1,2-diol alginate, agar, carrageenan, processed Eucheuma seaweed, locust bean gum, oat gum, guar gum, tragacanth, acacia gum, xanthan gum, karaya gum, tara gum, gellan gum, gum ghatti, polyoxyethene (8) stearate, aspartame-acesulfame salt, maltitol, amylase, proteases, invertase, polydextrose, polyvinylpyrrolidone, polyvinylpolypyrrolidone, dextrin, modified starch, alkaline modified starch, bleached starch, monostarch phosphate, distarch phosphate esterified with sodium trimetaphosphate or phosphorus oxychloride, phosphated distarch phosphate, starch acetate esterified with acetic anhydride, starch acetate acetified with vinyl acetate, acetylated distarch adipate, distarch glycerine, hydroxy propyl distarch glycerine, hydroxy propyl distarch phosphate, starch sodium octenyl succinate, triethyl citrate, oxidized starch, distarch glycerol, acetylated distarch phosphate, acetylated distarch glycerol, hydroxy propyl starch, hydroxyethyl cellulose, or a combination thereof.

In embodiments, the at least one food component may comprise at least one pH control agent selected from the group consisting of acetic acid, potassium acetate, sodium acetates, calcium acetate, carbon dioxide, malic acid, fumaric acid, sodium lactate, potassium lactate, calcium lactate, ammonium lactate, magnesium lactate, citric acid, sodium citrates, potassium citrates, calcium citrates, sodium tartrates, potassium tartrates, sodium potassium tartrate, lecithin citrate, magnesium citrate, ammonium malate, sodium malates, potassium malate, calcium malates, adipic acid, sodium adipate, potassium adipate, ammonium adipate, succinic acid, monosodium fumarate, potassium fumarate, calcium fumarate, ammonium fumarate, 1,4-heptonolactone, niacin, triammonium citrate, ammonium ferric citrate, calcium glycerylphosphate, isopropyl citrate, sodium carbonates, potassium carbonates, ammonium carbonates, magnesium carbonates, ferrous carbonate, ammonium chloride, ammonium sulfate, magnesium sulfate, aluminum potassium sulfate, aluminum ammonium sulfate, sodium hydroxide, potassium hydroxide, calcium hydroxide, ammonium hydroxide, magnesium hydroxide, calcium oxide, magnesium oxide, sodium ferrocyanide, dicalcium diphosphate, gluconic acid, glucono delta-lactone, or a combination thereof.

In embodiments, the at least one food component may comprise at least one acidulant selected from the group consisting of acetic acid, ascorbic acid, citric acid, fumaric acid, lactic acid, malic acid, phosphoric acid, tartaric acid, or a combination thereof.

In embodiments, the at least one food component may comprise at least one leavening agent selected from the group consisting of Saccharomyces cerevisiae, monocalcium phosphates, sodium aluminum sulfate, disodium pyrophosphate, sodium aluminum phosphates, sodium carbonates, or a combination thereof.

In embodiments, the at least one food component may comprise at least one anti-caking agent selected from the group consisting of calcium phosphates, magnesium phosphates, mannitol, sodium salts of fatty acids, potassium salts of fatty acids, calcium salts of fatty acids, magnesium salts of fatty acids, magnesium carbonates, magnesium oxide, sodium ferrocyanide, potassium ferrocyanide, ferrous hexacyanomanganate, calcium ferrocyanide, bone phosphate, sodium silicates, silicon dioxide, calcium silicate, magnesium silicates, talc, sodium aluminosilicate, potassium aluminum silicate, calcium aluminosilicate, zinc silicate, bentonite, aluminum silicate, potassium silicate, fatty acids, magnesium stearate, calcium stearate, dimethyl polysiloxane, or a combination thereof.

In embodiments, the at least one food component may comprise at least one humectant selected from the group consisting of sorbitol, maltitol, polydextrose, triacetin, propylene glycol, or a combination thereof.

In embodiments, the at least one food component may comprise at least one yeast nutrient selected from the group consisting of ammonium chloride, ammonium sulfate, ammonium phosphate, phosphoric acid, calcium iodate, or a combination thereof.

In embodiments, the at least one food component may comprise at least one dough strengthener or dough conditioner selected from the group consisting of ammonium chloride, calcium oxide, L-cysteine, L-cystine, potassium persulfate, ammonium persulfate, potassium bromate, calcium bromate, chlorine gas, azodicarbonamide, urea, benzoyl peroxide, calcium peroxide, or a combination thereof.

In embodiments, the at least one food component may comprise at least one firming agent selected from the group consisting of calcium gluconate, calcium hydrogen sulfite, calcium citrates, calcium phosphates, calcium chloride, magnesium chloride, magnesium sulfate, aluminum sulfate, aluminum sodium sulfate, calcium hydroxide, or a combination thereof.

In embodiments, the at least one food component may comprise at least one gas selected from the group consisting of argon, helium, nitrogen gas, nitrous oxide, butane, isobutane, propane, oxygen gas, hydrogen gas, carbon dioxide, or a combination thereof.

In embodiments, the at least one food component may comprise at least one vegetable selected from the group consisting of cabbage, Brussels sprouts, cauliflower, broccoli, kale, kohlrabi, red cabbage, Savoy cabbage, Chinese broccoli, collard greens, turnip, Chinese cabbage, napa cabbage, bok choy, radish, daikon, carrot, parsnip, beetroot, sea beet, Swiss chard, sugar beet, lettuce, celtuce, green bean, French bean, runner bean, haricot bean, Lima bean, broad bean, pea, snap pea, snow pea, split pea, potato, eggplant, tomato, cucumber, pumpkin, squash, marrow, zucchini, gourd, onion, spring onion, scallion, shallot, garlic, leek, elephant garlic, pepper, bell pepper, sweet pepper, spinach, yam, sweet potato, cassava, or a combination thereof.

In embodiments, the at least one food component may comprise at least one fruit selected from the group consisting of apple, apricot, banana, blackberry, blackcurrant, blueberry, boysenberry, cantaloupe, cherry, cranberry, fig, gooseberry, grape, grapefruit, guava, kiwifruit, lemon, lime, lucuma, mulberry, orange, Osage orange, pawpaw, peach, pear, pineapple, plum, pomegranate, raspberry, redcurrant, rose hip, strawberry, watermelon, or a combination thereof.

In embodiments, the at least one food component may comprise at least one meat product selected from the group consisting of pork, beef, mutton, veal, poultry, chevon, venison, chicken, duck, rabbit, goose, turkey, or a combination thereof.

In embodiments, the food product may be an analog food product selected from the group consisting of a butter analog, a margarine analog, a mayonnaise analog, a milk analog, a half-and-half analog, a light cream analog, a whipping cream analog, a heavy cream analog, a culinary cream analog, a manufacturer's cream analog, a bechamel sauce analog, an espagnole sauce analog, a hollandaise sauce analog, an alfredo sauce analog, a hummus analog, a Russian dressing analog, a tartar sauce analog, a Thousand Island dressing analog, a veloute sauce analog, a foie gras analog, a gelatin analog, a marmalade analog, a jam analog, a jelly analog, and a dessert pudding analog. The analog food product may, but need not, have a lower sugar content than a food product to which the analog food product is analogous. The analog food product may, but need not, have a lower fat content than a food product to which the analog food product is analogous.

In embodiments, the food product may be non-dairy. The food product may, but need not, be vegan.

In embodiments, the food product may be hypoallergenic.

In another aspect of the present disclosure, a method for making a food product comprises dividing a portion of a stable emulsion, gel, or sol from a packaged bulk form thereof, wherein the stable emulsion, gel, or sol comprises fungal mycelial biomass, an aqueous liquid, and one or more edible fats or oils, and combining the portion of the stable emulsion, gel, or sol with at least one food component to form a food product.

In embodiments, the at least one food component may comprise a flavoring, an herb, a spice, a flavor enhancer, a fat, a fat replacer, a preservative, a sweetener, a color additive, a nutrient, an emulsifier, a stabilizer or thickener, a pH control agent, an acidulant, a leavening agent, an anti-caking agent, a humectant, a yeast nutrient, a dough strengthener or dough conditioner, a firming agent, an enzyme preparation, a gas, a vegetable, a fruit, a meat product, citrus fiber, or a combination thereof.

In embodiments, the at least one food component may comprise at least one flavoring selected from the group consisting of allyl hexanoate, benzyl acetate, bornyl acetate, butyl acetate, butyl butyrate, butyl propionate, ethyl acetate, ethyl benzoate, ethyl butyrate, ethyl hexanoate, ethyl cinnamate, ethyl formate, ethyl heptanoate, ethyl isovalerate, ethyl lactate, ethyl nonanoate, ethyl pentanoate, geranyl acetate, geranyl butyrate, geranyl pentanoate, isobutyl acetate, isobutyl formate, isoamyl acetate, isopropyl acetate, linalyl acetate, linalyl butyrate, linalyl formate, methyl acetate, methyl anthranilate, methyl benzoate, methyl butyrate, methyl cinnamate, methyl formate, methyl pentanoate, methyl phenylacetate, methyl salicylate, nonyl caprylate, octyl acetate, octyl butyrate, amyl acetate, pentyl butyrate, pentyl hexanoate, pentyl pentanoate, propyl acetate, propyl hexanoate, propyl isobutyrate, terpenyl butyrate, chocolate, cocoa, vanilla bean, vanilla extract, vanilla paste, or a combination thereof.

In embodiments, the at least one food component may comprise at least one herb selected from the group consisting of angelica, basil, bay leaf, Indian bay leaf, boldo, borage, chervil, chives, cicely, cilantro, cilantro, cress, curry leaf, dill, epazote, hemp, hoja santa, Houlluynia cordala, hyssop, jimbu, Elsholtzia ciliata, Perilla frutescens, lavender, lemon balm, lemon grass, lemon myrtle, lemon verbena, rice paddy herb, lovage, marjoram, mint, mugwort, mitsuba, oregano, parsley, perilla, rosemary, rue, sage, savory, Zanthoxylum piperitum, shiso, sorrel, tarragon, thyme, woodruff, or a combination thereof.

In embodiments, the at least one food component may comprise at least one spice selected from the group consisting of aonori, ajwain, alligator pepper, allspice, amchoor, anise, asafoetida, peppercorn, Brazilian pepper, camphor, caraway, cardamom, cassia, celery powder, celery seed, charoli, chenpi, chili pepper, cinnamon, clove, coriander seed, cubeb, cumin, deulkkae, dill, fennel, fenugreek, fingerroot, galangal, garlic, ginger, aromatic ginger, golpar, grains of paradise, grains of Selim, horseradish, Japanese pricklyash, juniper berry, kokum, korarima, dried lime, liquorice, Lisea cubeba, long pepper, mango-ginger, mastic, mahleb, mustard, nigella, njangsa, nutmeg, onion powder, paprika, Peruvian pepper, pomegranate seed, poppy seed, radhuni, rose, saffron, sarsaparilla, sassafras, sesame, shiso, Sichuan pepper, sumac, tamarind, Tasmanian pepper, tonka bean, turmeric, uzazi, vanilla, voatsiperifery, wasabi, zedoary, zereshk, citrus fruit zest, or a combination thereof.

In embodiments, the at least one food component may comprise at least one flavor enhancer selected from the group consisting of glutamic acid, monosodium glutamate, monopotassium glutamate, calcium diglutamate, monoammonium glutamate, magnesium diglutamate, guanylic acid, disodium guanylate, dipotassium guanylate, calcium guanylate, inosinic acid, disodium inosinate, dipotassium inosinate, calcium inosinate, calcium 5′-ribonucleotides, disodium 5′-ribonucleotides, maltol, ethyl maltol, glycine, sodium salt of glycine, zinc acetate, gum benzoic, thaumatin, glycyrrhizin, neohesperidine dihydrochalcone, amylase, proteases, or a combination thereof.

In embodiments, the at least one food component may comprise at least one preservative selected from the group consisting of rowanberry extract, sorbic acid, sodium sorbate, potassium sorbate, calcium sorbate, heptyl p-hydroxybenzoate, benzoic acid, sodium benzoate, potassium benzoate, calcium benzoate, ethylparaben, sodium ethyl para-hydroxybenzoate, propylparaben, sodium propyl para-hydroxybenzoate, methylparaben, sodium methyl para-hydroxybenzoate, sulfur dioxide, sodium sulfite, sodium bisulfite, sodium metabisulfite, potassium metabisulfite, potassium sulfite, calcium sulfite, calcium hydrogen sulfite, potassium hydrogen sulfite, biphenyl, orthophenyl phenol, sodium orthophenyl phenol, thiabendazole, nisin, natamycin, formic acid, sodium formate, calcium formate, hexamine, formaldehyde, dimethyl dicarbonate, potassium nitrite, sodium nitrite, sodium nitrate, potassium nitrate, acetic acid, potassium acetate, sodium acetates, calcium acetate, ammonium acetate, dehydroacetic acid, sodium dehydroacetate, lactic acid, propionic acid, sodium propionate, calcium propionate, potassium propionate, boric acid, sodium tetraborate, carbon dioxide, malic acid, fumaric acid, copper(II) sulfate, chlorine gas, chlorine dioxide, lysozyme, or a combination thereof.

In embodiments, the at least one food component may comprise at least one sweetener selected from the group consisting of sorbitol, mannitol, glycerol, acesulfame potassium, aspartame, cyclamate, isomalt, saccharin, sodium salts of saccharin, potassium salts of saccharin, calcium salts of saccharin, sucralose, alitame, thaumatin, glycyrrhizin, neohesperidine dihydrochalcone, steviol glycosides, neotame, aspartame-acesulfame salt, maltitol, lactitol, xylitol, erythritol, advantame, sucrose, cane sugar, fructose, honey, agave nectar, mogrosides, or a combination thereof.

In embodiments, the at least one food component may comprise at least one color additive selected from the group consisting of curcumin, riboflavin, riboflavin-5′-phosphate, tartrazine, alkannin, Quinoline Yellow WS, Fast Yellow AB, riboflavin-5′-sodium phosphate, Yellow 2G, sunset yellow FCF, Orange GGN, carmine, carminic acid, Citrus Red 2, carmoisine, amaranth, Ponceau 4R, Scarlet GN, Ponceau 6R, erythrosine, Red 2G, Allura Red AC, indanthrone blue, Patent Blue V, indigo carmine, brilliant blue FCF, chlorophylls, chlorophyllins, copper complexes of chlorophylls and chlorophyllins, Green S, fast green FCF, plain caramel, caustic sulfite caramel, ammonia caramel, sulfite ammonia caramel, Brilliant Black BN, carbon black, vegetable carbon, Brown FK, Brown HT, carotenes, annatto, bixin, norbixin, paprika oleoresin, lycopene, beta-apo-8′-carotenal, ethyl ester of beta-apo-8′-carotenal, flavoxanthin, lutein, cryptoxanthin, rubixanthin, violaxanthin, rhodoxanthin, canthaxanthin, zeaxanthin, citranaxanthin, astaxanthin, betanin, anthocyanins, saffron, calcium carbonate, titanium dioxide, iron oxides, iron hydroxides, aluminum, silver, gold, Lithol Rubine BK, tannins, orcein, or a combination thereof.

In embodiments, the at least one food component may comprise at least one nutrient selected from the group consisting of glucose, sucrose, ribose, amylose, amylopectin, maltose, galactose, fructose, lactose, alanine, arginine, aspartic acid, asparagine, cysteine, glutamic acid, glutamine, glycine, histidine, isoleucine, leucine, lysine, methionine, phenylalanine, proline, serine, threonine, tryptophan, tyrosine, valine, acetic acid, propionic acid, butyric acid, valeric acid, caproic acid, caprylic acid, lauric acid, myristic acid, pentadecanoic acid, palmitic acid, margaric acid, stearic acid, arachidic acid, behenic acid, lignoceric acid, cerotic acid, myristoleic acid, oleic acid, eicosenoic acid, erucic acid, nervonic acid, linoleic acid, alpha-linolenic acid, stearidonic acid, gamma-linolenic acid, arachidonic acid, eicosatetraenoic acid, timnodonic acid, clupanodonic acid, cervonic acid, calcium, sulfur, phosphorus, magnesium, sodium, potassium, iron, zinc, boron, copper, chromium, selenium, manganese, molybdenum, cobalt, fluorine, iodine, thiamin, riboflavin, niacin, pantothenic acid, pyridoxine, pyridoxal-5-phosphate, pyridoxamine, biotin, folate, cobalamin, choline, vitamin A, ascorbic acid, ergocalciferol, cholecalciferol, tocopherols, tocotrienols, phylloquinone, menaquinone, menadione, or a combination thereof.

In embodiments, the at least one food component may comprise at least one emulsifier selected from the group consisting of lecithin, metatartaric acid, calcium tartrate, alginic acid, sodium alginate, potassium alginate, ammonium alginate, calcium alginate, propane-1,2-diol alginate, carrageenan, processed Eucheuma seaweed, locust bean gum, tragacanth, acacia gum, karaya gum, gellan gum, gum ghatti, sorbitol, glycerol, konjac, polyoxyethene (8) stearate, polyoxyethene (40) stearate, polysorbate 20, polysorbate 80, polysorbate 40, polysorbate 60, polysorbate 65, pectins, gelatine, ammonium phosphatides, brominated vegetable oil, sucrose acetate isobutyrate, glycerol esters of wood rosins, diphosphates, triphosphates, polyphosphates, beta-cyclodextrin, cellulose, methyl cellulose, ethyl cellulose, hydroxypropyl cellulose, Hypromellose, ethyl methyl cellulose, carboxymethyl cellulose, sodium carboxymethyl cellulose, croscarmellose, enzymically hydrolyzed carboxymethylcellulose, sodium salts of fatty acids, potassium salts of fatty acids, calcium salts of fatty acids, magnesium salts of fatty acids, mono- and diglycerides of fatty acids, acetic acid esters of mono- and diglycerides of fatty acids, lactic acid esters of mono- and diglycerides of fatty acids, citric acid esters of mono- and diglycerides of fatty acids, tartaric acid esters of mono- and diglycerides of fatty acids, mono- and diacetyl tartaric acid esters of mono- and diglycerides of fatty acids, mixed acetic and tartaric acid esters of mono- and diglycerides of fatty acids, succinylated monoglycerides, sucrose esters of fatty acids, sucroglycerides, polyglycerol esters of fatty acids, polyglycerol polyricinoleate, propane-1,2-diol esters of fatty acids, propylene glycol esters of fatty acids, lactylated fatty acid esters of glycerol and propane-1, thermally oxidized soybean oil interacted with mono- and diglycerides of fatty acids, dioctyl sodium sulfosuccinate, sodium stearoyl-2-lactylate, calcium stearoyl-2-lactylate, stearyl tartrate, stearyl citrate, sodium stearoyl fumarate, calcium stearoyl fumarate, sodium laurylsulfate, ethoxylated mono- and diglycerides, methyl glucoside-coconut oil ester, sorbitan monostearate, sorbitan tristearate, sorbitan monolaurate, sorbitan monooleate, sorbitan monopalmitate, sorbitan trioleate, dicalcium diphosphate, sodium aluminum phosphate, calcium sodium polyphosphate, calcium polyphosphate, ammonium polyphosphate, magnesium stearate, calcium stearate, cholic acid, choline salts, oxidized starch, distarch glycerol, acetylated distarch phosphate, hydroxy propyl starch, starch sodium octenyl succinate, acetylated oxidized starch, or a combination thereof.

In embodiments, the at least one food component may comprise at least one stabilizer or thickener selected from the group consisting of oxystearin, alginic acid, sodium alginate, potassium alginate, ammonium alginate, calcium alginate, propane-1,2-diol alginate, agar, carrageenan, processed Eucheuma seaweed, locust bean gum, oat gum, guar gum, tragacanth, acacia gum, xanthan gum, karaya gum, tara gum, gellan gum, gum ghatti, polyoxyethene (8) stearate, aspartame-acesulfame salt, maltitol, amylase, proteases, invertase, polydextrose, polyvinylpyrrolidone, polyvinylpolypyrrolidone, dextrin, modified starch, alkaline modified starch, bleached starch, monostarch phosphate, distarch phosphate esterified with sodium trimetaphosphate or phosphorus oxychloride, phosphated distarch phosphate, starch acetate esterified with acetic anhydride, starch acetate acetified with vinyl acetate, acetylated distarch adipate, distarch glycerine, hydroxy propyl distarch glycerine, hydroxy propyl distarch phosphate, starch sodium octenyl succinate, triethyl citrate, oxidized starch, distarch glycerol, acetylated distarch phosphate, acetylated distarch glycerol, hydroxy propyl starch, hydroxyethyl cellulose, or a combination thereof.

In embodiments, the at least one food component may comprise at least one pH control agent selected from the group consisting of acetic acid, potassium acetate, sodium acetates, calcium acetate, carbon dioxide, malic acid, fumaric acid, sodium lactate, potassium lactate, calcium lactate, ammonium lactate, magnesium lactate, citric acid, sodium citrates, potassium citrates, calcium citrates, sodium tartrates, potassium tartrates, sodium potassium tartrate, lecithin citrate, magnesium citrate, ammonium malate, sodium malates, potassium malate, calcium malates, adipic acid, sodium adipate, potassium adipate, ammonium adipate, succinic acid, monosodium fumarate, potassium fumarate, calcium fumarate, ammonium fumarate, 1,4-heptonolactone, niacin, triammonium citrate, ammonium ferric citrate, calcium glycerylphosphate, isopropyl citrate, sodium carbonates, potassium carbonates, ammonium carbonates, magnesium carbonates, ferrous carbonate, ammonium chloride, ammonium sulfate, magnesium sulfate, aluminum potassium sulfate, aluminum ammonium sulfate, sodium hydroxide, potassium hydroxide, calcium hydroxide, ammonium hydroxide, magnesium hydroxide, calcium oxide, magnesium oxide, sodium ferrocyanide, dicalcium diphosphate, gluconic acid, glucono delta-lactone, or a combination thereof.

In embodiments, the at least one food component may comprise at least one acidulant selected from the group consisting of acetic acid, ascorbic acid, citric acid, fumaric acid, lactic acid, malic acid, phosphoric acid, tartaric acid, or a combination thereof.

In embodiments, the at least one food component may comprise at least one leavening agent selected from the group consisting of Saccharomyces cerevisiae, monocalcium phosphates, sodium aluminum sulfate, disodium pyrophosphate, sodium aluminum phosphates, sodium carbonates, or a combination thereof.

In embodiments, the at least one food component may comprise at least one anti-caking agent selected from the group consisting of calcium phosphates, magnesium phosphates, mannitol, sodium salts of fatty acids, potassium salts of fatty acids, calcium salts of fatty acids, magnesium salts of fatty acids, magnesium carbonates, magnesium oxide, sodium ferrocyanide, potassium ferrocyanide, ferrous hexacyanomanganate, calcium ferrocyanide, bone phosphate, sodium silicates, silicon dioxide, calcium silicate, magnesium silicates, talc, sodium aluminosilicate, potassium aluminum silicate, calcium aluminosilicate, zinc silicate, bentonite, aluminum silicate, potassium silicate, fatty acids, magnesium stearate, calcium stearate, dimethyl polysiloxane, or a combination thereof.

In embodiments, the at least one food component may comprise at least one humectant selected from the group consisting of sorbitol, maltitol, polydextrose, triacetin, propylene glycol, or a combination thereof.

In embodiments, the at least one food component may comprise at least one yeast nutrient selected from the group consisting of ammonium chloride, ammonium sulfate, ammonium phosphate, phosphoric acid, calcium iodate, or a combination thereof.

In embodiments, the at least one food component may comprise at least one dough strengthener or dough conditioner selected from the group consisting of ammonium chloride, calcium oxide, L-cysteine, L-cystine, potassium persulfate, ammonium persulfate, potassium bromate, calcium bromate, chlorine gas, azodicarbonamide, urea, benzoyl peroxide, calcium peroxide, or a combination thereof.

In embodiments, the at least one food component may comprise at least one firming agent selected from the group consisting of calcium gluconate, calcium hydrogen sulfite, calcium citrates, calcium phosphates, calcium chloride, magnesium chloride, magnesium sulfate, aluminum sulfate, aluminum sodium sulfate, calcium hydroxide, or a combination thereof.

In embodiments, the at least one food component may comprise at least one gas selected from the group consisting of argon, helium, nitrogen gas, nitrous oxide, butane, isobutane, propane, oxygen gas, hydrogen gas, carbon dioxide, or a combination thereof.

In embodiments, the at least one food component may comprise at least one vegetable selected from the group consisting of cabbage, Brussels sprouts, cauliflower, broccoli, kale, kohlrabi, red cabbage, Savoy cabbage, Chinese broccoli, collard greens, turnip, Chinese cabbage, napa cabbage, bok choy, radish, daikon, carrot, parsnip, beetroot, sea beet, Swiss chard, sugar beet, lettuce, celtuce, green bean, French bean, runner bean, haricot bean, Lima bean, broad bean, pea, snap pea, snow pea, split pea, potato, eggplant, tomato, cucumber, pumpkin, squash, marrow, zucchini, gourd, onion, spring onion, scallion, shallot, garlic, leek, elephant garlic, pepper, bell pepper, sweet pepper, spinach, yam, sweet potato, cassava, or a combination thereof.

In embodiments, the at least one food component may comprise at least one fruit selected from the group consisting of apple, apricot, banana, blackberry, blackcurrant, blueberry, boysenberry, cantaloupe, cherry, cranberry, fig, gooseberry, grape, grapefruit, guava, kiwifruit, lemon, lime, lucuma, mulberry, orange, Osage orange, pawpaw, peach, pear, pineapple, plum, pomegranate, raspberry, redcurrant, rose hip, strawberry, watermelon, or a combination thereof.

In embodiments, the at least one food component may comprise at least one meat product selected from the group consisting of pork, beef, mutton, veal, poultry, chevon, venison, chicken, duck, rabbit, goose, turkey, or a combination thereof.

In embodiments, the food product may be selected from the group consisting of a butter analog, a margarine analog, a mayonnaise analog, a milk analog, a half-and-half analog, a light cream analog, a whipping cream analog, a heavy cream analog, a manufacturer's cream analog, a culinary cream analog, a béchamel sauce analog, an espagnole sauce analog, a hollandaise sauce analog, an alfredo sauce analog, a hummus analog, a Russian dressing analog, a tartar sauce analog, a Thousand Island dressing analog, a veloute sauce analog, a foie gras analog, a gelatin analog, a marmalade analog, a jam analog, a jelly analog, and a dessert pudding analog.

In embodiments, an interval between a time at which the packaged bulk form is initially packaged and the combining step, during which the dividing step is performed, may be at least about one day, at least about two days, at least about three days, at least about four days, at least about five days, at least about six days, at least about one week, at least about two weeks, at least about three weeks, at least about one month, at least about two months, at least about three months, at least about four months, at least about five months, at least about six months, at least about seven months, at least about eight months, at least about nine months, at least about ten months, at least about eleven months, at least about twelve months, at least about thirteen months, at least about fourteen months, at least about fifteen months, at least about sixteen months, at least about seventeen months, or at least about eighteen months. During at least part of the interval, the stable emulsion, gel, or sol may, but need not, be maintained at room temperature. During at least part of the interval, the stable emulsion, gel, or sol may, but need not, be refrigerated.

In embodiments, the method may further comprise, before the dividing step, transporting the bulk form of the stable emulsion, gel, or sol.

In embodiments, the method may further comprise, after the dividing step and before the combining step, transporting the portion of the stable emulsion, gel, or sol.

In another aspect of the present disclosure, a method for making a food product comprises contacting a food base composition with at least one food component, wherein the food base composition comprises fungal mycelial biomass, an aqueous liquid, and one or more edible fats or oils and is in the form an emulsion, gel, or sol; and subjecting the contacted food base composition and food component to an acidic condition, a heat condition, a cold condition, or combinations thereof, wherein the food base composition does not separate into an aqueous phase and an edible fat or oil phase during the contacting step or the subjecting step.

In embodiments, the subjecting step may comprise acidifying the contacted food base composition and food component. The subjecting step may, but need not, comprise acidifying the contacted food base composition and food component to a pH of 6.5 or lower.

In embodiments, the subjecting step may comprise heating the contacted food base composition and food component. The subjecting step may, but need not, comprise heating the contacted food base composition and food component to a temperature of 35° C. or higher.

In embodiments, the subjecting step may comprise cooling the contacted food base composition and food component. The subjecting step may, but need not, comprise cooling the contacted food base composition and food component to a temperature of 4° C. or lower.

In embodiments, the subjecting step may comprise acidifying and heating the contacted food base composition and food component. The subjecting step may, but need not, comprise acidifying the contacted food base composition and food component to a pH of 6.5 or lower and heating the contacted food base composition and food component to a temperature of 35° C. or higher.

In embodiments, the food base composition may comprise fungal mycelial biomass, in an amount of about 2 wt % to about 15 wt %; an aqueous liquid, in an amount of about 20 wt % to about 80 wt %; and one or more edible fats or oils, in an amount of about 10 wt % to about 80 wt %.

In embodiments, the food base composition may be non-dairy. The food product may, but need not, be non-dairy. The food base composition may, but need not, be vegan. The food product may, but need not, be vegan.

In embodiments, the contacted food base composition and food component may not form a stable foam during the contacting step. The contacted food base composition and food component may, but need not, have an overrun of less than about 20%.

In embodiments, the food product may be selected from a butter analog, a margarine analog, a mayonnaise analog, a milk analog, a half-and-half analog, a light cream analog, a whipping cream analog, a heavy cream analog, a manufacturer's cream analog, a béchamel sauce analog, an espagnole sauce analog, a hollandaise sauce analog, an alfredo sauce analog, a hummus analog, a Russian dressing analog, a tartar sauce analog, a Thousand Island dressing analog, a veloute sauce analog, a foie gras analog, a gelatin analog, a marmalade analog, a jam analog, a jelly analog, and a dessert pudding analog.

In embodiments, the fungal mycelial biomass may comprise proteins having an isoelectric point of 6.0 or less.

In embodiments, the contacting step may comprise mixing the contacted food base composition and the food component.

While specific embodiments and applications have been illustrated and described, the present disclosure is not limited to the precise configuration and components described herein. Various modifications, changes, and variations which will be apparent to those skilled in the art may be made in the arrangement, operation, and details of the methods and systems disclosed herein without departing from the spirit and scope of the overall disclosure.

As used herein, unless otherwise specified, the terms “about,” “approximately,” etc., when used in relation to numerical limitations or ranges, mean that the recited limitation or range may vary by up to 10%. By way of non-limiting example, “about 750” can mean as little as 675 or as much as 825, or any value therebetween. When used in relation to ratios or relationships between two or more numerical limitations or ranges, the terms “about,” “approximately,” etc. mean that each of the limitations or ranges may vary by up to 10%; by way of non-limiting example, a statement that two quantities are “approximately equal” can mean that a ratio between the two quantities is as little as 0.9:1.1 or as much as 1.0.1:0.9 (or any value therebetween), and a statement that a four-way ratio is “about 5:3:1:1” can mean that the first number in the ratio can be any value of at least 4.5 and no more than 5.5, the second number in the ratio can be any value of at least 2.7 and no more than 3.3, and so on.

The embodiments and configurations described herein are neither complete nor exhaustive. As will be appreciated, other embodiments are possible utilizing, alone or in combination, one or more of the features set forth above or described in detail below.

### BRIEF DESCRIPTION OF THE DRAWINGS

FIG. 1 is an illustration of a method for making a food product, according to embodiments of the present disclosure.

FIG. 2 is an image of competitor Product 1 (left, labeled “A”) and Product 3 (right, labeled “B”) after being heated and then cooled as described in Example 4a.

FIG. 3 is an image of competitor Product 1 (left) and Product 3 (right) after adding acid and being heated and then cooled as described in Example 4a.

FIG. 4 is an image of competitor Product 1 (left) and Product 3 (right) after adding acid and cooling as described in Example 4a.

FIG. 5 is an image of competitor Product 2 after being heated and cooled (left), after adding acid and being heated and cooled (middle), and after adding acid and cooling (right) as described in Example 4a.

FIG. 6 is an image of the fungal non-dairy culinary cream substitute of Example 4b (left) and a 3:1 dilution (right) after being heated as described in Example 4b.

FIG. 7 is an image of the fungal non-dairy culinary cream substitute of Example 4b (left) and a 3:1 dilution (right) after being heated and cooled as described in Example 4b.

FIGS. 8A through 8C are images of the fungal non-dairy culinary cream substitute of Example 4b (FIG. 8A and on the left in FIG. 8C) and a 3:1 dilution (FIG. 8B and on the right in FIG. 8C) after adding acid and heating as described in Example 4b.

FIGS. 9A through 9C are images of the fungal non-dairy culinary cream substitute of Example 4b (FIG. 9B and on the left in FIG. 9A) and a 3:1 dilution (FIG. 9C and on the right in FIG. 9A) after adding acid and cooling as described in Example 4b.

### DETAILED DESCRIPTION

Unless defined otherwise, all technical and scientific terms used herein have the same meaning as is commonly understood by one of ordinary skill in the art. All patents, applications, published applications, and other publications to which reference is made herein are incorporated by reference in their entirety. If there is a plurality of definitions for a term herein, the definition provided in the Summary prevails unless otherwise stated.

As used herein, unless otherwise specified, the term “analog” or “analog food product” refers to a food product comprising edible fungi that bears an aesthetic, culinary, nutritional, and/or sensory equivalence or resemblance to an identified non-fungal food product. By way of non-limiting example, an “ice cream analog product,” as that term is used herein, refers to a food product comprising edible fungi that bears an aesthetic, culinary, nutritional, and/or sensory equivalence or resemblance to conventional ice cream made from animal milk, and a “mayonnaise analog food product,” as that term is used herein, refers to a food product comprising edible fungi that bears an aesthetic, culinary, nutritional, and/or sensory equivalence or resemblance to conventional mayonnaise made using animal products.

As used herein, unless otherwise specified, the term “biomass” refers to a mass of a living or formerly living organism, including fungal, microbial, and plant biomass. Microbial biomass sources can include bacterial, fungal (including higher fungi), and microalgal biomass sources. Plant biomass sources can include any source of plant-based biopolymers such as cellulose, lignin and pectin. By way of non-limiting example, the phrase “filamentous fungal biomass” as used herein refers to a mass of a living or formerly living filamentous fungus. Most biomasses include significant quantities of water, and therefore, unless otherwise specified, references herein to the proportion of biomass in a multi-component composition relate to the “dry” portion of the biomass, i.e., the mass of all constituent parts of the biomass other than water; by way of non-limiting example, in a food base composition that is referred to herein as comprising 10 wt % biomass, all constituent parts of the biomass other than water collectively make up 10 wt % of the total mass of the food base composition. Similarly, unless otherwise specified, percentages of non-water components of a biomass, such as proteins, RNA, lipids, etc., are given on a dry basis; by way of non-limiting example, a statement herein that a biomass has a protein content of 25 wt % means that proteins make up 25 wt % of the dry (i.e., non-water) mass of the biomass.

As used herein, unless otherwise specified, the term “biomat” refers to a cohesive mass of filamentous fungal tissue comprising a network of interwoven hyphae filaments. Biomats as that term is used herein may, but need not, be characterized by one or more of a density of between about 50 and about 200 grams per liter, a solids content of between about 5 wt % and about 20 wt %, and sufficient tensile strength to be lifted substantially intact from the surface of a growth substrate (e.g., a liquid growth medium, a solid fungal composite, or a solid membrane or mesh). Biomats, as that term is used herein, may be produced by any one or more fungal fermentation methods known in the art, such as, by way of non-limiting example, methods described in PCT Application Publications 2020/176758, 2020/154722 and 2018/014004.

As used herein, unless otherwise specified, the term “bulk form” means an amount of a material greater than that which is typically used at a single time. Materials in “bulk form,” as that term is used herein, are thus generally manufactured, packaged, shipped, and/or stored in such a way that an end user may divide a portion of the material from the bulk form and store the remainder of the bulk form for future use(s).

As used herein, unless otherwise specified, the term “cohesive” refers to any material that has sufficient structural integrity and tensile strength to be picked up and/or physically manipulated by hand as a solid object, without tearing or collapsing.

As used herein, unless otherwise specified, the term “colloid” refers to a mixture in which particles of one substance (the “dispersed phase”) are dispersed throughout a volume of a different substance (the “dispersion medium”); for example, the dispersed phase can comprise or consist of microscopic bubbles, particles, etc. Where the dispersed phase and the dispersion medium of a colloid are specifically identified herein, they are separated by a hyphen, with the dispersed phase identified first, e.g., a reference herein to an “oil-water colloid” refers to a colloid in which an oil is the dispersed phase and water is the dispersion medium.

As used herein, unless otherwise specified, the terms “edible fat” and “edible oil” each refer to a formulation of one or more lipids that can be safely consumed by an animal (most typically, but by no means exclusively, a human). The terms are distinguished by the physical state of the formulation at room temperature and ambient pressure; a “edible fat,” as that term is used herein, is solid at room temperature and ambient pressure, whereas a “edible oil,” as that term is used herein, is liquid at room temperature and ambient pressure.

As used herein, unless otherwise specified, the term “emulsion” refers to a colloid in which both the dispersed phase and the dispersion medium are liquids. Examples of emulsions as that term is used herein include but are not limited to butter (when melted), margarine (when melted), mayonnaise, and milk.

As used herein, unless otherwise specified, the term “filamentous fungus” refers to any multicellular fungus that is capable of forming an interconnected network of hyphae (vegetative hyphae or aerial hyphae, and most commonly both) known as “mycelium.” Examples of filamentous fungi as that term is used herein include, but are by no means limited to, fungi of the genera Acremonium, Alternaria, Aspergillus, Cladosporium, Fusarium, Mucor, Penicillium, Rhizopus, Stachybotrys, Trichoderma, and Trichophyton, among many others, with specific examples including Fusarium strain flavolapis (ATCC Accession Deposit No. PTA-10698) and Fusarium venenatum. It is to be expressly understood that filamentous fungi, as that term is used herein, may be capable of forming other fungal structures, such as fruiting bodies, in addition to hyphae/mycelium.

As used herein, unless otherwise specified, the term “foam” refers to a colloid in which the dispersed phase is a gas, and the dispersion medium is a liquid. Examples of foams as that term is used herein include but are not limited to egg white foam (i.e., the product of whisking, or otherwise incorporating, air into egg white) and whipped cream.

As used herein, unless otherwise specified, the term “foam stability” refers to the proportion of an initial volume of a foam that is retained by the foam after a specified interval. By way of non-limiting example, a foam that has an initial volume of five liters and a volume of four liters 14 days later thus has 80% stability over 14 days. Unless otherwise specified, a “stable” foam, as that term is used herein, is a foam that has at least 50% stability after a specified interval.

As used herein, unless otherwise specified, the term “food base composition” refers to an edible composition having chemical and/or physical properties allowing it to serve as a “base” or starting material for one or more food products (preferably, many and/or diverse food products), and which can be transformed into such food products by being mixed or otherwise combined with one or more additional food components, e.g., flavorings, herbs, spices, flavor enhancers, fats, fat replacers, preservatives, sweeteners, color additives, nutrients, emulsifiers, stabilizers, thickeners, pH control agents, acidulants, leavening agents, anti-caking agents, humectants, yeast nutrients, dough strengtheners, dough conditioners, firming agents, enzymes, gases, vegetables, fruits, meat products, etc.

As used herein, unless otherwise specified, the terms “fungal mycelial matter,” “fungal mycelial biomass,” and “mycelial biomass” are interchangeable and each refer to a biomass of filamentous fungus in which fungal mycelium makes up at least about 30 wt % of the biomass. In embodiments, fungal mycelium may make up at least about 50 wt %, at least about 55 wt %, at least about 60 wt %, at least about 65 wt %, at least about 70 wt %, at least about 75 wt %, at least about 80 wt %, at least about 85 wt %, at least about 90 wt %, at least about 95 wt %, at least about 96 wt %, at least about 97 wt %, at least about 98 wt %, at least about 99 wt %, or substantially all of the biomass. Fungal mycelium grown in submerged fermentation can exist as filaments or in pellet form pellets (i.e., spherical pellets consisting of aggregated hyphal structures). In embodiments, fungal mycelium comprises filaments. In embodiments, fungal mycelium does not comprise pellets. In embodiments, fungal mycelium comprises filaments and pellets. The remainder (i.e., the non-mycelial portion) of the mycelial biomass may contain other fungal tissues (conidia, fruiting bodies, etc.). “Mycelial biomass” specifically includes biomass produced by any fermentation method and thus encompasses biomass produced by submerged fermentation methods and non-submerged fermentation methods. In some embodiments, a mycelial biomass is produced by any one or more submerged fermentation methods known in the art, such as, for example, those described in U.S. Pat. No. 7,635,492 to Finnigan et al., In other embodiments, a mycelial biomass is a “cohesive mycelial biomass” produced by a fermentation process other than a submerged fermentation process. A “cohesive mycelial biomass” has sufficient tensile strength and structural integrity to be picked up and moved by hand without disintegrating or tearing and is produced by any one or more fungal fermentation methods in which the filamentous fungus grows in such a way as to form a mass of interwoven mycelia, e.g., methods in which a fungal mycelium is grown in air or a controlled atmosphere out of a growth medium or feedstock (e.g., liquid surface fermentation, fermentation on the surface of a membrane or mesh scaffold, solid substrate fermentations in which mycelial biomass grows free of solid substrate, etc.). Examples of methods of producing a “cohesive mycelial biomass” are described in PCT Application Publications 2020/176758, 2020/154722, and 2018/014004. Generally speaking, mycelial biomasses recovered from submerged fermentation processes are not cohesive mycelial biomasses. More specifically, as used herein, unless otherwise specified, the term “consisting essentially of fungal mycelium” refers to any material that includes at least about 95 wt %/o fungal mycelium on a dry basis.

As used herein, unless otherwise specified, the term “gel” refers to a colloid in which the dispersed phase is a liquid, and the dispersion medium is a solid. Examples of gels as that term is used herein include but are not limited to blancmange, butter (when cold), custard (after it is cooked), jam, jelly (after it is set), and margarine (when cold). Gels, as that term is used herein, may behave as solids or semi-solids and typically have an elastic modulus greater than their dynamic (or loss) modulus, and thus do not readily flow.

As used herein, unless otherwise specified, the term “liquid aerosol” refers to a colloid in which the dispersed phase is a liquid, and the dispersion medium is a gas.

As used herein, unless otherwise specified, the terms “semi-finished” and “intermediate,” when used in reference to a product or good (e.g., a food product), are interchangeable and each mean that the product or good is in a form that has undergone some chemical and/or mechanical processing and is adapted or configured to be used as an input in further chemical and/or mechanical processing to manufacture a “finished good” for sale to, or use by, an end user. By way of non-limiting example, a bulk form of a colloidal food composition as disclosed herein may be a semi-finished or intermediate good where it is adapted or configured to be divided into portions and at least one of these portions may be used to form a finished food product (e.g., a salad dressing, etc.).

As used herein, unless otherwise specified, the term “package,” in verb form, means to store a material in a container in such a way as to reduce the material's exposure to at least one of light, oxygen, temperature fluctuations, and biological and/or chemical contamination; the container itself is, by extension, referred to as “packaging” or a “package.” Non-limiting examples of types of “packaging,” as that term is used herein, that may be suitable for packaging edible materials include aseptic packaging, trays, bags, cans, cartons, and/or flexible polymeric and/or biopolymeric packaging, these containers may, as part of a “packaging” process, then be packaged in secondary, tertiary, etc. containers, such as boxes, pallets, wrappers, and the like.

As used herein, unless otherwise specified, the term “separate,” when used in verb form with reference to a colloid, refers to a phenomenon in which at least the majority (by mass or volume) of one or more phases of the colloid segregates from (i.e., fails to remain homogeneously mixed with) one or more other phases of the colloid and forms a distinct phase, layer, etc. of the colloid. By logical extension, a colloid in which, over a defined period, at least 50% (by mass or volume) of all phases remain substantially homogeneously mixed and do not segregate to form distinct phases, layers, etc. may be referred to herein as not having “separated” over that period, unless otherwise specified. Where specifically referenced herein, alternate understandings of the term “separate” can mean that at least about 45%, at least about 40%, at least about 35%, at least about 30%, at least about 25%, at least about 20%, at least about 15%, at least about 10%, or at least about 5% (by mass or volume) of one or more phases of the colloid segregates from (i.e., fails to remain homogeneously mixed with) one or more other phases of the colloid to form a distinct phase, layer, etc. of the colloid.

As used herein, unless otherwise specified, the term “sol” refers to a colloid in which the dispersed phase is a solid and the dispersion medium is a liquid. Examples of sols as that term is used herein include but are not limited to custard (before it is cooked) and jelly (before it is set).

As used herein, unless otherwise specified, the term “solid aerosol” refers to a colloid in which the dispersed phase is a solid and the dispersion medium is a gas.

As used herein, unless otherwise specified, the term “solid foam” refers to a colloid in which the dispersed phase is a gas, and the dispersion medium is a solid. Examples of solid foams as that term is used herein include but are not limited to bread, cake, ice cream, and meringue.

As used herein, unless otherwise specified, the term “solid sol” refers to a colloid in which both the dispersed phase and the dispersion medium are solids.

As used herein, unless otherwise specified, the term “vegan” refers to a food product that is substantially free of food components or ingredients, such as protein, derived from animals. Specific examples of non-vegan food ingredients or products include blood, eggs, isinglass, meat (and components thereof, e.g., animal fats), milk, rennet, and foods made using any one or more of these ingredients (e.g., ice cream, mayonnaise, etc.). As disclosed herein, some vegan food products may be analogs of non-vegan food products.

Embodiments of the present disclosure include colloidal suspensions of filamentous fungi, typically colloidal suspensions of edible filamentous fungi, and most typically colloidal food base compositions, i.e., edible colloidal compositions that can serve as a “base” or starting material for a finished colloidal food product adapted for consumption by humans or domesticated, farmed (e.g., agriculture or aquaculture), or livestock animals, and that can be transformed into the finished food product by being mixed or otherwise combined with one or more other food components, e.g., flavorings, herbs, spices, flavor enhancers, fats, fat replacers, preservatives, sweeteners, color additives, nutrients, emulsifiers, stabilizers, thickeners, pH control agents, acidulants, leavening agents, anti-caking agents, humectants, yeast nutrients, dough strengtheners, dough conditioners, firming agents, enzymes, gases, vegetables, fruits, meat products, etc. The food base compositions of the present disclosure include at least fungal mycelial biomass, an aqueous liquid, and one or more edible fats or oils. In some embodiments, the colloidal food base composition may be suitable to combined with one or more other food components to form a food product that is analogous to a conventional or known food product comprising a dairy or otherwise animal-derived ingredient (milk, egg, etc.); the fungal mycelial biomass may be provided in addition to or in lieu of the animal-derived ingredient. In some embodiments, the colloidal food base composition may be a non-dairy composition and may be a vegan (i.e., no animal-derived components) composition. In some embodiments, the colloidal food base composition may be a hypoallergenic composition. Examples of colloidal food products that can be made using the food base compositions of the present disclosure include, without limitation, batters, blancmange, bread, butter, cake, condiments, custard, dips, egg white foam, ice cream, jam, jelly, margarine, mayonnaise, meringue, milk, soup, whipped cream, and many sauces and spreads (e.g., béchamel sauce, espagnole sauce, hollandaise sauce, alfredo sauce, hummus, Russian dressing, tartar sauce, Thousand Island dressing, velouté sauce, etc.), and/or analogs thereof. In some embodiments, the colloidal food base composition and/or a colloidal food product made therefrom is/are gluten-free.

In some embodiments, the colloidal food product may be a non-dairy product and may be a vegan (i.e., no animal-derived components) product. In some embodiments, the colloidal food product may be a hypoallergenic product.

In embodiments, the colloidal food base composition that can serve as a “base” or starting material for a finished colloidal food product is white in color. The “whiteness” (measured, in some embodiments, as an absence of other pigments) of colloidal composition can be determined via the use of a colorimeter (e.g., a ColorFlex® Spectrocolorimeter, Hunter Associates Laboratory, Reston, VA) and measured L*, a*, and b* values. “L*” represents lightness (100-0), “a*” redness (+) or greenness (−), and “b*” yellowness (+) or blueness (−) of a sample on the CIE L*, a*, b* scale. The measurement of the quantities of CIE L*a*b* using a colorimeter can be used to determine the Whiteness Index of a substance in relationship with physical observation. In some embodiments, this scale can be used as described in ASTM E 308 Standard Practice for Computing the Colors of Objects by Using the CIE System (ASTM International, West Conshohocken, PA, USA), where the Whiteness Index is calculated by the formula (L*/b*)−a*. Using this standard, typically a value of >7.5 implies the sample looks white to the human eye based on physical observation. The theoretical “perfect white” has reference values of 100% across the visible spectrum with corresponding colorimetric values of L*=100.00, a*=0.00 and b*=0.00. An item that is only near white may be darker, having a lower L* value, and possibly be slightly chromatic either in the red-green dimension (a*) or in the yellow-blue dimension (b*). In some embodiments, colloidal food base compositions according to the present disclosure may have an L* value of at least about 65, at least about 70, at least about 75, at least about 80, at least about 81, at least about 82, at least about 83, at least about 84, at least about 85, at least about 86, at least about 87, at least about 88, at least about 89, at least about 90, at least about 91, at least about 92, at least about 93, at least about 94, or at least about 95; an a* value of no more than about 5, no more than about 4, no more than about 3, no more than about 2, no more than about 1.9, no more than about 1.8, no more than about 1.7, no more than about 1.6, no more than about 1.5, no more than about 1.4, no more than about 1.3, no more than about 1.2, no more than about 1.1, no more than about 1.0, no more than about 0.9, no more than about 0.8, no more than about 0.7, no more than about 0.6, no more than about 0.5, no more than about 0.4, or no more than about 0.3; and/or a b* value of no more than about 15, no more than about 14, no more than about 13, no more than about 12, no more than about 11, or no more than about 10.

The specific colloidal form taken by the food base compositions of the present disclosure may vary depending on the intended use of the food base composition (e.g., the food product or products intended to be made using the food base composition), and particularly on the physical state of the one or more edible fats or oils present in the food base composition, which may be present as liquid, solid, or a combination thereof. Particularly, the aqueous liquid may be a dispersed phase and the one or more edible fats or oils may be a dispersion medium (such that the colloid is an emulsion or gel), or the aqueous liquid may be a dispersion medium and the one or more edible fats or oils may be a dispersed phase (such that the colloid is an emulsion or sol). The colloidal food base composition may be any type of fat-water, oil-water, water-fat, or water-oil colloid. In some embodiments, the fungal mycelial biomass may act to stabilize interfacial tension of an interface between fat/oil and water and/or, in those embodiments in which the colloid further includes a culinary gas (e.g., argon, helium, nitrogen gas, nitrous oxide, butane, isobutane, propane, oxygen gas, hydrogen gas, carbon dioxide, etc.), the fungal mycelial biomass may stabilize an interface between any two of fat/oil, gas, and water, and the colloid may be a “double” or more complex colloid (e.g., air-in-oil-in-water, air-in-fat-in-water, air-in-water-in-oil, air-in-water-in-fat, water-in-oil-in-water, water-in-fat-in-water, oil-in-water-in-oil, fat-in-water-in-oil, oil-in-water-in-fat, fat-in-water-in-fat, air-in-water-in-oil, etc.).

Any edible fat and/or oil can generally be used in the colloidal food base compositions of the present disclosure, and those of ordinary skill in the art will readily understand how to select the appropriate fat/oil or combination of fats/oils for a given application, based, by way of non-limiting example, on the desired physical and chemical properties of the fat/oil (e.g., content of saturated, unsaturated, monounsaturated, and/or polyunsaturated fats, food energy content, melting point, boiling point, smoke point, solidity, density, viscosity, refractive index, pH, iodine value, saponification value, peroxide value, etc.). Non-limiting examples of suitable edible fats/oils include almond oil, ambadi seed oil, apple seed oil, argan oil, avocado oil, beech nut oil, beef and/or mutton fats (e.g., dripping, suet, tallow, tail fat), bitter gourd oil, blubber/whale oil, bottle gourd oil, Brazil nut oil, buffalo gourd oil, butternut squash seed oil, cashew oil, castor oil, coconut oil, corn oil, cottonseed oil, dairy fats (e.g., butter, ghee, niter kibbeh, smen), diacylglycerol (DAG) oil, egusi seed oil, fish oils (e.g., cod liver oil, shark liver oil), grape seed oil, grapefruit seed oil, hazelnut oil, hemp oil, Jamaican cobnut oil, lemon oil, linseed oil, macadamia oil, marula oil, mongongo nut oil, mustard oil, olive oil, orange oil, palm oil, peanut oil, pecan oil, perilla oil, pine nut oil, pistachio oil, poppyseed oil, pork fats (e.g., fatback, lard, lardon, pork belly, speck), poultry fats (e.g., chicken fat, duck fat, schmaltz), pumpkin seed oil, rapeseed oil, rice bran oil, safflower oil, sesame oil, soybean oil, sunflower oil, tea seed oil, vegetable fats (e.g., Borneo tallow, cocoa butter, mango butter, margarine, shea butter, vegetable shortening), walnut oil, and watermelon seed oil.

Typically, the fungal mycelial biomass is provided in food base compositions of the present disclosure in amounts such that the dry biomass (i.e., the biomass excluding water) makes up from about 2 wt % to about 15 wt % (or any subrange thereof) of the colloidal food base composition. Due to the colloid-stabilizing properties of fungal mycelial biomass as further described herein, and to enable the colloidal food base composition to be combined with further aqueous and/or fatty/oil additives, components, and ingredients while remaining in colloidal form, the aqueous liquid and the one or more edible fats or oils may be provided in a wide range of quantities without excessively compromising the stability of the colloid, although both the aqueous liquid (including any water in the fungal mycelial biomass) and the one or more edible fats or oils are most typically present in an amount of at least about 10 wt % up to about 80 wt % (and in any subrange thereof) of the colloidal food base composition. Generally, the aqueous liquid and the one or more edible fats or oils may be provided in any weight ratio from about 1:4 (or, equivalently, 20:80) to about 4:1 (or, equivalently, 80:20), and this ratio may be varied depending on the desired chemical, physical, and/or culinary properties of the colloidal food base composition and/or colloidal food products intended to be made therefrom. Particularly, the aqueous liquid: fat/oil ratio may be varied to modify the viscosity of the colloidal food base composition; a lower aqueous liquid: fat/oil ratio may result in a thicker/more viscous food base composition (which may be especially suitable for making highly viscous spreads, sauces, or condiments, e.g., ketchup, peanut butter, etc., or analogs thereof), whereas a higher aqueous liquid: fat/oil ratio may result in a thinner/less viscous food base composition (which may be especially suitable for making milk analogs or other beverages).

In many embodiments, the fungal mycelial biomass will provide a substantial fraction, and generally at least the majority, of the protein in the colloidal food base composition. Particularly, the fungal mycelial biomass may provide at least about 50 wt %, at least about 55 wt %, at least about 60 wt %, at least about 65 wt %, at least about 70 wt %, at least about 75 wt %, at least about 80 wt %, at least about 85 wt %, at least about 90 wt %, at least about 95 wt %, at least about 96 wt %, at least about 97 wt %, at least about 98 wt %, at least about 99 wt %, or substantially all of the protein in the colloidal food base composition. Additionally or alternatively, the colloidal food base composition may also include one or more animal proteins (e.g., as a meat filler or meat extender) and/or one or more non-animal, non-fungal proteins, such as a plant (pea, potato, soy, etc.) protein or algal protein; inclusion of plant and/or algal proteins may be useful to ensure that the colloidal food base composition remains vegetarian and/or vegan. In some embodiments, the protein content of the fungal mycelial biomass may allow the fungal mycelial biomass to take the place of a protein-rich ingredient found in conventional food products/compositions, particularly an animal-derived ingredient (e.g., milk, egg, etc.), whereas in other embodiments the fungal mycelial biomass may be provided in addition to or as a partial replacement for a protein-rich ingredient to augment the protein content of the food product. The fungal mycelial biomass may comprise at least about 30%, at least about 31 wt %, at least about 32 wt %, at least about 33 wt %, at least about 34 wt %, at least about 35 wt %, at least about 36 wt %, at least about 37 wt %, at least about 38 wt %, at least about 39 wt %, at least about 40 wt %, at least about 41 wt %, at least about 42 wt %, at least about 43 wt %, at least about 44 wt %, at least about 45 wt %, at least about 46 wt %, at least about 47 wt %, at least about 48 wt %, at least about 49 wt %, at least about 50 wt %, at least about 51 wt %, at least about 52 wt %, at least about 53 wt %, at least about 54 wt %, at least about 55 wt %, at least about 56 wt %, at least about 57 wt %, at least about 58 wt %, at least about 59 wt %, at least about 60 wt % protein content, at least about 61 wt %, at least about 62 wt %, at least about 63 wt %, at least about 64 wt %, at least about 65 wt %, at least about 66 wt %, at least about 67 wt %, at least about 68 wt %, at least about 69 wt %, at least about 70 wt %, at least about 71 wt %, at least about 72 wt %, at least about 73 wt %, at least about 74 wt %, at least about 77 wt %, at least about 76 wt %, at least about 77 wt %, at least about 78 wt %, at least about 79 wt %, or at least about 80 wt % protein content. Alternatively, in embodiments of the disclosure, filamentous fungi can comprise protein in a range between 30 wt % and 80 wt % or in any whole number percentage range between 30 wt % and 80 wt %. As a result, the colloidal food base compositions of the present disclosure may thus have a notably high or enriched protein content, which may in embodiments be about at least about 4.0 wt %, at least about 4.5 wt %, at least about 5.0 wt %, at least about 5.5 wt %, at least about 6.0 wt %, at least about 6.5 wt %, at least about 7.0 wt %, at least about 7.5 wt %, at least about 8.0 wt %, at least about 8.5 wt %, at least about 9.0 wt %, at least about 9.5 wt %, at least about 10.0 wt %, at least about 10.5 wt %, at least about 11.0 wt %, at least about 11.5 wt %, at least about 12.0 wt %, or at least about 12.5 wt % of the colloidal food base composition.

In addition to having a high overall protein content, fungal mycelial biomass in colloidal food base compositions of the present disclosure may provide advantageous protein compositions or chemistries. By way of first non-limiting example, the fungal mycelial biomass may represent a “complete” protein source by providing all nine essential amino acids and/or all 20 proteinogenic amino acids. By way of second non-limiting example, the fungal mycelial biomass may comprise at least one branched-chain amino acid (e.g., leucine, isoleucine, valine), and may in some embodiments contain such amino acids in amounts of at least about 10 wt %, at least about 15 wt %, at least about 20 wt %, at least about 25 wt %, or at least about 30 wt %.

A further nutritional or compositional advantage provided by the colloidal food base compositions of the present disclosure is that the protein content may in some embodiments be higher than the protein content of conventional colloidal food base compositions. In many embodiments, the protein content of the colloidal food base composition on a total weight basis is between about 1.0 wt % and about 10.0 wt %, or between about 3.0 wt % and about 6.5 wt %, or alternatively in any subrange from any tenth of a weight percent between 1.0 wt % and 10.0 wt % (inclusive) to any other tenth of a weight percent between 1.0 wt % and 10.0 wt % (inclusive). Particularly, colloidal food base compositions according to some embodiments of the present disclosure may comprise at least about 150 mg, at least about 300 mg, at least about 450 mg, at least about 600 mg, at least about 750 mg, at least about 900 mg, at least about 1.05 g, at least about 1.2 g, at least about 1.35 g, or at least about 1.5 g of protein per 15 mL (1 tablespoon) of the colloidal food base composition.

Fungal mycelial biomass may provide various other nutritional or compositional advantages to the colloidal food base compositions of the present disclosure as well. By way of non-limiting example, the fungal mycelial biomass may have an advantageously high content of dietary fiber and thus be suitable, upon being mixed or otherwise combined with additional food components/ingredients, for the creation of high-fiber food products (and in particular high-fiber alternatives to or analogs of conventional food products that may have lower fiber contents); in some embodiments, the fungal mycelial biomass may comprise at least about 27 wt %, at least about 28 wt %, at least about 29 wt %, at least about 30 wt %, at least about 31 wt %, at least about 32 wt %, at least about 33 wt %, at least about 34 wt %, at least about 35 wt %, or at least about 36 wt % dietary fiber. A high fiber content may be advantageous for any one or more additional reasons not directly related to nutritional composition, e.g. improved hydration properties (such as decreased water activity to allow for easier preparation/storage and longer shelf life), increased satiation or “fullness” upon eating (which may encourage consumers to eat more moderate portions of “indulgence” products such as ice cream analog food products or mayonnaise analog food products and thereby aid in preventing or mitigating adverse health effects such as high cholesterol), improved digestibility, etc.

Alternatively, the fungal mycelial biomass may have an advantageously low content of dietary fiber; in some embodiments, the fugal mycelial biomass may comprise no more than about 26 wt %, no more than about 25 wt %, no more than about 24 wt %, no more than about 23 wt %, no more than about 22 wt %, no more than about 21 wt %, no more than about 20 wt %, no more than about 19 wt %, no more than about 18 wt %, no more than about 17 wt %, no more than about 16 wt %, no more than about 15 wt %, no more than about 14 wt %, no more than about 13 wt %, no more than about 12 wt %, no more than about 11 wt %, no more than about 10 wt %, no more than about 9 wt %, no more than about 8 wt %, no more than about 7 wt %, no more than about 6 wt %, no more than about 5 wt %, no more than about 4 wt %, no more than about 3 wt %, no more than about 2 wt %, or no more than about 1 wt % dietary fiber. A low fiber content may be advantageous for any of a number of reasons, such as, by way of non-limiting example, providing the ability to combine the fungal mycelial biomass with other proteins in a food product while keeping the total fiber content of the food product low enough to avoid causing gastric discomfort or distress in a consumer of the food product.

In many embodiments, the dietary fiber content of the colloidal food base composition is between about 0.25 wt % and about 8.0 wt %, or between about 0.5 wt % and about 6.0 wt %, or alternatively in any subrange from any tenth of a weight percent between 0.25 wt % and 8.0 wt % (inclusive) to any other tenth of a weight percent between 0.25 wt % and 8.0 wt % (inclusive). Particularly, colloidal food base compositions according to some embodiments of the present disclosure may comprise at least about 150 mg, at least about 300 mg, at least about 450 mg, at least about 600 mg, or at least about 750 mg of dietary fiber per 15 mL (1 tablespoon) of the colloidal food base composition.

In some embodiments, colloidal food base compositions according to the present disclosure may have an advantageously low food energy content, e.g., as may be suitable to prepare a low-calorie food product, a reduced-calorie analog of a conventional food product, etc., or simply to allow the food base composition to be combined with other ingredients to provide a food product with a desired food energy content. Particularly, colloidal food base compositions according the present disclosure may have a food energy content of no more than about 40 kcal, no more than about 35 kcal, no more than about 30 kcal, no more than about 25 kcal, or no more than about 20 kcal per 15 mL (1 tablespoon) of the colloidal food base composition.

One advantageous nutritional or compositional feature provided by the fungal mycelial biomass in colloidal food base compositions of the present disclosure is that these particles may provide a beneficially high content of phospholipids, i.e., lipid molecules having both a hydrophilic “head” (containing a negatively charged phosphate group) and two hydrophobic “tails” (derived from fatty acids and joined by an alcohol residue). Because phospholipids have appreciable non-polar and polar regions within the same molecule, they are amphiphilic molecules that can adsorb to oil-water interfaces and stabilize lipid droplets in a colloid. As a result of these properties, phospholipids can act as emulsifiers and are the major components of lecithin, a substance found in egg yolk that is widely used as a food emulsifier (including, especially, in conventional mayonnaise); however, some commercial lecithin ingredients are not particularly good at stabilizing oil-in-water emulsions when used in isolation because they have low or intermediate hydrophilic-lipophilic balance numbers (HLB values between about 2 and about 8). These same properties allow phospholipids to act as an emulsifying agent in milk (and therefore in dairy-based colloids such as ice cream), preventing the fat globules in the milk from aggregating and coalescing in the aqueous environment of the milk and thus preventing separation, or “creaming,” of the milk for an extended period, and have further been shown to improve the heat stability of dairy products. Thus, in the practice of the present disclosure, it is possible to provide fungal mycelial biomass that, because they include phospholipids in substantial quantities, naturally act as an emulsifier to stabilize the colloidal composition, which may in embodiments allow the quantity of other emulsifiers to be reduced or even eliminated when preparing the colloidal composition to produce a “cleaner” product (as some conventional emulsifiers may produce a “gummy,” “sticky,” or “tacky” texture) and promote or control release of flavoring ingredients. In some embodiments, the fungal mycelial biomass may comprise phospholipids in amounts of at least about 11.0 μmol/g, at least about 11.5 μmol/g, at least about 12.0 μmol/g, at least about 12.5 μmol/g, at least about 13.0 μmol/g, at least about 13.5 mol/g, at least about 14.0 μmol/g, or at least about 14.5 μmol/g. The fungal mycelial biomass may, additionally or alternatively, comprise phospholipids in amounts of at least about 0.01 wt %, at least about 0.02 wt %, at least about 0.03 wt %, at least about 0.04 wt %, at least about 0.05 wt %, at least about 0.1 wt %, at least about 0.15 wt %, at least about 0.2 wt %, at least about 0.25 wt %, at least about 0.3 wt %, at least about 0.35 wt %, at least about 0.4 wt %4, at least about 0.45 wt %, at least about 0.5 wt %, at least about 0.6 wt %, at least about 0.7 wt %, at least about 0.8 wt %, at least about 0.9 wt %, at least about 1.0 wt %, at least about 1.1 wt %, at least about 1.2 wt %, at least about 1.3 wt %, at least about 1.4 wt %, at least about 1.5 wt %, at least about 1.6 wt %, at least about 1.7 wt %, at least about 1.8 wt %, at least about 1.9 wt %, at least about 2.0 wt %, at least about 2.1 wt %, at least about 2.2 wt %, at least about 2.3 wt %, at least about 2.4 wt %, at least about 2.5 wt %, at least about 2.6 wt %, at least about 2.7 wt %, at least about 2.8 wt %, at least about 2.9 wt %, or at least about 3.0 wt %. In turn, the colloidal composition as a whole may comprise phospholipids in amounts of at least about 0.01 wt %, at least about 0.02 wt %, at least about 0.03 wt %, at least about 0.04 wt %, at least about 0.05 wt %, at least about 0.1 wt %, at least about 0.15 wt %, at least about 0.2 wt %, at least about 0.25 wt %, at least about 0.3 wt %, at least about 0.35 wt %, at least about 0.4 wt %, at least about 0.45 wt %, at least about 0.5 wt %, at least about 0.6 wt %, at least about 0.7 wt %, at least about 0.8 wt %, at least about 0.9 wt %, at least about 1.0 wt %, at least about 1.1 wt %, at least about 1.2 wt %, at least about 1.3 wt %, at least about 1.4 wt %, at least about 1.5 wt %, at least about 1.6 wt %, at least about 1.7 wt %, at least about 1.8 wt %, at least about 1.9 wt %, at least about 2.0 wt %, at least about 2.1 wt %, at least about 2.2 wt %, at least about 2.3 wt %, at least about 2.4 wt %, at least about 2.5 wt %, at least about 2.6 wt %, at least about 2.7 wt %, at least about 2.8 wt %, at least about 2.9 wt %, or at least about 3.0 wt %.

It is to be expressly understood that any one or more of various other chemical constituents of filamentous fungi may also serve as emulsifiers, surfactants, or surface-active agents (e.g., to reduce surface tension between the fat/oil phase and the aqueous phase, and/or to coat fat/oil particles to prevent them from coalescing), foam stabilizers, etc. Without wishing to be bound by any particular theory, non-limiting examples of such constituents may include proteins, saccharides (e.g. polysaccharides, mono- and diglycerides of fatty acids, lactic acid esters, propylene glycol esters, etc.), amphiphilic compounds other than phospholipids, extracellular polymeric substances (EPSs), or even compounds present on the surface of fungal cells as residues left over from fermentation processes (e.g. salts or nutrients from a fungal growth medium). In some embodiments, the filamentous fungus as a whole, or a single compound or group of compounds therein, may serve multiple functions; for example, as the solid or semi-solid phase of an ice cream analog food product is itself a complex colloid of water ice, sugars, etc., the fungal mycelial biomass, or a single compound or group of compounds therein, may act as both an emulsifier (of the various solid- and/or liquid-phase species that make up the dispersion medium for air) and a foam stabilizer (of air in the dispersion medium) of food products made using the food base compositions of the disclosure. The fungal mycelial biomass may, in some embodiments, even act to provide still further advantageous chemical, mechanical, and/or rheological properties to the colloidal food base compositions of the disclosure, in some cases improving these properties even beyond those of conventional non-fungal food products to which the compositions are analogous; by way of non-limiting example, the fungal mycelial biomass may raise the freezing point of the colloidal food base composition and in some embodiments may do so to a greater extent than common stabilizers such as locust bean gum or guar gum (e.g. to allow ice cream analog food products made using the food base composition to remain solid at higher temperatures than conventional ice creams), thicken or bind the dispersion medium (e.g. as a matrix material substituting for gluten to provide for creation of a gluten-free bread or cake analog food product), and so on.

A further nutritional or compositional advantage provided by the colloidal food base compositions of the present disclosure is that the filamentous fungi may be produced by methods that enable the filamentous fungi to contain functional compounds that may not be present in, or cannot be delivered by, conventional food products. By way of first non-limiting example, the growth media in which filamentous fungi are produced may be imparted with any one or more beneficial nutrients or compounds (vitamins, lipids, glycolipids, polysaccharides, sugar alcohols, ω-3 fatty acids, etc.) that may be taken up by the fungus and thus passed on to the consumer of the colloidal food product. By way of second non-limiting example, the growth media in which filamentous fungi are produced may be imparted with any one or more compounds (e.g., pigments, inks, dyes, fragrances, etc.) that may be taken up by the fungus and improve an aesthetic or sensory quality of the filamentous fungus. By way of third non-limiting example, the growth media in which filamentous fungi are produced may be characterized by a desired or preselected mass ratio of carbon to nitrogen (“C:N ratio”), which may most typically be between about 1:1 and about 50:1, or between about 2.5:1 and about 30:1, or between about 5:1 and about 10:1, or alternatively in any range having a lower bound of X:1 and an upper bound of Y:1, where X and Y are each whole numbers or halves of whole numbers equal to at least 1 and no more than 50; the growth media may, for example, have a C:N ratio of about 2.5:1, about 5:1, about 7.5:1, about 10:1, about 12.5:1, about 15:1, about 17.5:1, about 20:1, about 22.5:1, about 25:1, about 27.5:1, about 30:1, about 32.5:1, about 35:1, about 37.5:1, about 40:1, about 42.5:1, about 45:1, about 47.5:1, or about 50:1, or alternatively about any ratio of the form X:2 where X is an integer between about 2 and about 100. A selected C:N ratio may allow the filamentous fungi to have a desired or selected fat content, protein content, or ratio of fat to protein.

A further nutritional or composition advantage provided by the colloidal food base compositions of the present disclosure is that the compositions may be free of allergens and/or animal-derived products that may otherwise prevent persons with allergenic sensitivities or dietary restrictions (e.g., vegans) from consuming analogous conventional food products. By way of non-limiting example, analogs of a wide variety of conventional colloidal food products (e.g., ice cream, mayonnaise, etc.) that are lactose-free, egg-free, soy-free, dairy-free, nut-free, and/or gluten-free may be produced according to the present disclosure. Even more advantageously, these problematic ingredients can in some embodiments be replaced by components having nutritional benefits, e.g., lactose may be replaced by one or more β-glucans.

In embodiments, at least a portion of the fungal mycelial biomass may be provided as a “flour,” i.e., as relatively fine particles suitable for dispersion in a colloidal dispersion medium and/or stabilization of other phases in a colloidal system; particles of this type may be produced by any of a number of techniques that will be readily appreciated by those of ordinary skill in the art, e.g., size reduction of fungal biomass produced by a surface fermentation process, spray-drying of fungal biomass produced by a submerged fermentation process, and so on. Often, filamentous fungal particles suitable for use in colloidal food base compositions according to the disclosure will have a length of between about 0.05 mm and about 500 mm, a width of between about 0.03 mm and about 7 mm, and a height of between about 0.03 mm and about 1.0 mm, and most often will have a particle size of between about 0.03 mm and 0.4 mm. In some embodiments, filamentous fungal particles provided as a flour may have an average particle size of between about 75 microns and about 100 microns, and in some embodiments may have a 5*^{h}-percentile particle size of about 75 microns and a 95*^{h}-percentile particle size of about 180 microns. In other embodiments, filamentous fungal particles provided as a flour may have a 10′^{h}-percentile particle size of between about 1 micron and about 5 microns, a median particle size of between about 10 microns and about microns, and a 90th-percentile particle size of between about 20 microns and about 30 microns. In some embodiments, the fungal mycelial biomass flour, a colloidal food base composition comprising the fungal mycelial biomass flour, and/or a colloidal food product made therefrom is/are gluten-free.

In some embodiments, a “dry” filamentous fungal flour (i.e. a filamentous fungal powder with a relatively low moisture content, typically between about 4 wt % and about 14 wt % and most typically no more than about 12 wt %) may be used directly in the colloidal food base composition, whereas in other embodiments the filamentous fungal particles may be dispersed in a suitable dispersion medium (typically water) to form a “milk” that may be used to produce the colloidal food base composition. Typically, a weight ratio of water to fungal particles in such dispersions may be between about 1:10 and about 10:1, or in any subrange therebetween. Alternatively, the ratio may be between about 2.5 and about 3.5, or between about 2.6 and about 3.4, or between about 2.7 and about 3.3, or between about 2.8 and about 3.2, or between about 2.9 and about 3.1, or about 3.0.

The filamentous fungi suitable for use in the disclosure (either as biomats or as particles in food materials) may be selected from the phyla or divisions zygomycota, glomermycota, chytridiomycota, basidiomycota or ascomycota. The phylum (or division) basidiomycota comprises, inter alia, the orders Agaricales, Russulales, Polyporales and Ustilaginales; the phylum ascomycota comprises, inter alia, the orders Pezizales and Hypocreales; and the phylum zygomycota comprises, inter alia, the order Mucorales. The particles of edible filamentous fungi of the present disclosure belong to an order selected from Ustilaginales, Russulales, Polyporales, Agaricales, Pezizales, Hypocreales and Mucorales.

In some embodiments, the filamentous fungi of the order Ustilaginales are selected from the family Ustilaginaceae. In some embodiments, the filamentous fungi of the order Russulales are selected from the family Hericiaceae. In some embodiments, the filamentous fungi of the order Polyporales are selected from the families Polyporaceae or Grifolaceae. In some embodiments, the filamentous fungi of the order Agaricales are selected from the families Lyophyllaceae, Strophariaceae, Lycoperdaceae, Agaricaceae, Pleurotaceae, Physalacriaceae, or Omphalotaceae.

In some embodiments, the filamentous fungi of the order Pezizales are selected from the families Tuberaceae or Morchellaceae. In some embodiments, the filamentous fungi of the order Mucorales are selected from the family Mucoraceae.

In some embodiments, the filamentous fungi may be selected from the genera Fusarium, Aspergillus, Trichoderma, Rhizopus, Rhizomucor, Ustilago, Hericululm, Polyporous, Grifola, Hypsizygus, Calocybe, Pholiota, Calvatia, Stropharia, Agaricus, Hypholoma, Pleurotus, Morchella, Sparassis, Disciotis, Cordvceps, Ganoderma, Flammulina, Lentimila, Ophiocordyceps. Trametes, Ceriporia, Leucoagaricus, Handkea, Monascus and Neurospora.

Examples of the species of filamentous fungi include, without limitation, Ustilago esculenta, Hericululm erinaceus, Polyporous squamosus, Grifola fondrosa, Hypsizygus marmoreus, Hypsizygus ulmarinos (elm oyster) Calocybe gambosa, Pholiota namelko, Cakvalia gigantea, Agaricus bisporus, Stropharia rugosoammlata, Hypholoma lateritium, Pleurotus eryngh, Pleurotus ostreatus (pearl), Pleurotus ostrealus var. columbimis (Blue oyster), Tuber borchii, Morchella esculenta, Morchella conica, Morchella importuna, Sparassis crispa (cauliflower), Fusarium venenalum, Fusarium strain flavolapis, Disciotis venosa, Cordyceps militaris, Ganoderma lucidum (reishi), Flammulina velutipes, Lentimla edodes, Ophiocordyceps sinensis. Additional examples include, without limitation, Trametes versicolor, Ceriporia lacerate, Pholiota gigantea, Leucoagaricus holosericeus, Pleurotus djamor, Calvatia fragilis, Handkea utriformis, Rhizopus oligosporus, Rhizomucor pusillus, and Neurospora crassa.

In some embodiments, the filamentous fungus is a Fusarium species. In some embodiments, the filamentous fungus is the Fusarium strain flavolapis that was deposited with the American Type Culture Collection, 1081 University Boulevard, Manassas, Virginia, USA and assigned ATCC Accession Deposit No. PTA-10698. Fusarium strain flavolapis ATCC Accession Deposit No. PTA-10698 was previously reported to be a Fusarium oxysporum strain and was originally referred to by the designation MK7. However, it has subsequently been identified as not being an oxysporum strain and is considered a novel strain of Fusarium that has been provisionally named Fusarium str. flavolapis. In some embodiments, the filamentous fungus is the Fusarium strain Fusarium venenatum.

Fungal biomass from which the fungal mycelial biomass in colloidal food base compositions of the disclosure are derived may be produced by a surface fermentation process as described in PCT Application Publication WO 2017/151684, a submerged fermentation process, a solid-state or solid substrate fermentation process, an air-medium colloid fermentation process, and/or a method as disclosed in PCT Application Publication WO2019/099474 (“the '474 publication”), the entirety of which is incorporated herein by reference. The fungal mycelial biomass can be derived from a fungal biomass that is completely or substantially completely formed of mycelium; additionally or alternatively, fungal mycelium may make up at least about 55 wt %, at least about 60 wt %, at least about 65 wt %, at least about 70 wt %, at least about 75 wt %, at least about 80 wt %, at least about 85 wt %, at least about 90 wt %, at least about 95 wt %, at least about 96 wt %, at least about 97 wt %, at least about 98 wt %, at least about 99 wt %, or substantially all of the fungal mycelial biomass. Further, the fungal mycelial biomass can be derived from a fungal biomass that comprises conidia. In addition, the fungal mycelial biomass can comprise a mixture of mycelium, conidia, and fruiting body material. In some embodiments, the fungal mycelial biomass may be a cohesive fungal biomass, such as a filamentous fungal biomat.

The colloidal food base compositions and/or food products made therefrom of the present disclosure may have a wide range of pH and remain stable (e.g., not separate). Conventional colloidal food products often become unstable and separate at lower pH values. It has been observed that many conventional or alternative colloidal food base compositions of lower pH separate more rapidly when heated; for example, both conventional cream cheeses and vegan cream cheese analogs have been observed to separate at temperatures as low as 50° C. when the pH of these products is relatively low. Some culinary creams and cream alternatives, including products containing thickeners and/or stabilizers such as xanthan gum, guar gum, and/or sunflower lecithin, have also been observed to separate and/or undergo a change in texture and/or color when heated or when undergoing a drop in pH. In contrast, colloidal food base compositions and food products of the invention have been found to be advantageously stable at low pH and/or when subjected to heating and/or cooling conditions. Thus, embodiments of the present disclosure include colloidal food base compositions and food products having a pH of 6.5 or lower, 6.0 or lower, 5.5 or lower, 5.0 or lower, 4.5 or lower, 4.0 or lower, 3.5 or lower, or 3.0 or lower. Alternatively, such food base compositions and food products can have a pH in a range from 3.0 to 6.5 or any subrange thereof. This characteristic of the food base compositions and food products of the invention are particularly important when food products requiring acidification, such as by the addition of lemon juice, are being prepared.

Alternatively, the colloidal food base compositions of the present disclosure may advantageously have a relatively low pH and/or a pH that is lower than that of an analogous conventional colloidal food product. Particularly, this lower pH may improve the coagulation properties and/or rheology of the colloidal food base compositions for certain applications, as it has been observed that colloidal food base compositions may thicken at lower pH due to aggregation of proteins. Thus, embodiments of the present disclosure include colloidal food base compositions having a pH of no more than about 14, no more than about 13, no more than about 12, no more than about 11, no more than about 10, no more than about 9, no more than about 8, no more than about 7, no more than about 6, no more than about 5, no more than about 4, no more than about 3, no more than about 2, no more than about 1, or no more than about 0.

In some embodiments, colloidal food base compositions according to the present disclosure may have a pH of about 4.0 to about 7.0, or alternatively of any value in any subrange having a lower bound of any tenth of a pH unit from pH 4.0 to pH 6.5 and an upper bound of any other tenth of a pH unit from pH 4.0 to pH 6.5 (e.g., a range of about pH 5.0 to about pH 7.0, a range of about pH 5.5 to about pH 6.5, a range of about pH 5.7 to about pH 6.2, etc.). More particularly, the pH of the colloidal food base composition in such embodiments may be about 4.0, about 4.1, about 4.2, about 4.3, about 4.4, about 4.5, about 4.6, about 4.7, about 4.8, about 4.9, about 5.0, about 5.1, about 5.2, about 5.3, about 5.4, about 5.5, about 5.6, about 5.7, about 5.8, about 5.9, about 6.0, about 6.1, about 6.2, about 6.3, about 6.4, about 6.5, about 6.6, about 6.7, about 6.8, about 6.9, or about 7.0.

In some embodiments, a filamentous fungal biomass component of a colloidal food base composition according to the present disclosure may comprise proteins whose isoelectric point (i.e., the pH at which the surfaces of the proteins have no net electrical charge or are electrically neutral) is no more than about 6.0, or more particularly from about 3.0 to about 6.0, or alternatively is in any subrange having a lower bound of any tenth of a pH unit from pH 3.0 to pH 6.0 and an upper bound of any other tenth of a pH unit from pH 3.0 to pH 6.0. More particularly, the isoelectric point of the proteins in the filamentous fungal biomass component of the colloidal food base composition in such embodiments may be about 3.0, about 3.1, about 3.2, about 3.3, about 3.4, about 3.5, about 3.6, about 3.7, about 3.8, about 3.9, about 4.0, about 4.1, about 4.2, about 4.3, about 4.4, about 4.5, about 4.6, about 4.7, about 4.8, about 4.9, about 5.0, about 5.1, about 5.2, about 5.3, about 5.4, about 5.5, about 5.6, about 5.7, about 5.8, about 5.9, or about 6.0.

A chemical and/or physical characteristic of the colloidal food base compositions of the present disclosure is the stability of the colloid, i.e., the degree to which the two phases of the colloid remain homogeneously mixed with each other over a period. The stability of the colloid not only allows the colloidal food base composition to maintain desired aesthetic, chemical, physical, or textural properties over an extended period, but may enable the colloid to be stored and/or transported for a significant period after formulation, providing stable product integrity, texture, taste, and eating experience. As known in the prior art, both viscosity and surface charge of dispersed colloidal particles are key enablers of colloidal compositions. Viscosity and zeta potential measurements of colloidal dispersions comprising Fusarium strain flavolapis are summarized in Table 6. In these samples, zeta potential ranged from −20.9 mV to −35.62 mV, which points towards the charge density that is required for a colloidal dispersion to maintain stability and reduce creaming, agglomeration, or flocculation of the dispersed phase. One skilled in the prior art can apply common additives such as salts, surfactants, stabilizers, and so on to further improve the charge density difference between colloidal particles and suspending medium. In embodiments, the dispersed phase and the dispersion medium of colloidal food base compositions of the present disclosure may remain substantially homogenously mixed, and/or may not visibly separate, for at least about one day, at least about two days, at least about three days, at least about four days, at least about five days, at least about six days, at least about one week, at least about two weeks, at least about three weeks, at least about one month, at least about two months, at least about three months, at least about four months, at least about five months, at least about six months, at least about seven months, at least about eight months, at least about nine months, at least about ten months, at least about eleven months, at least about twelve months, at least about thirteen months, at least about fourteen months, at least about fifteen months, at least about sixteen months, at least about seventeen months, or at least about eighteen months after formation of the colloidal composition.

The stability of colloidal food base compositions of the present disclosure may, in some embodiments, be quantified in terms of the zeta potential of the colloid. The zeta potential of the colloid is the electric potential difference between the dispersion medium and a stationary layer of fluid attached to the dispersed particle; it is caused by the net electrical charge contained within the region bounded by, and depends on the location of, the slipping plane. Zeta potential may be expressed using either positive or negative units of voltage (depending on the charge). Generally, colloids with large positive or large negative zeta potential are considered electrically stabilized, while emulsions with zeta potentials closer to zero tend to be physically unstable and can exhibit rapid aggregation or flocculation of the dispersed phase. Zeta potential is thus a key parameter for predicting the physical stability of a colloid, alongside other parameters such as interfacial layer thickness, viscosity, temperature, pH, and the presence or absence of additives that may affect the interfacial surface charge between two phases on either side of an interface (air, water, lipid, etc., as well as complex combinations thereof as in double colloids). In embodiments of the present disclosure, the colloidal food base composition may have a zeta potential magnitude, at 20° C. and a pH of between 5 and 7, of at least about 5 mV, at least about 10 mV, at least about 15 mV, at least about 20 mV, at least about 25 mV, at least about 30 mV, at least about 35 mV, at least about mV, at least about 45 mV, at least about 50 mV, at least about 55 mV, or at least about 60 mV.

In embodiments, it may be possible to control the zeta potential and viscosity, and thus the stability, of colloidal food base compositions of the present disclosure by employing particular production and handling techniques of components of the compositions, particularly including the fungal mycelial biomass. By way of first non-limiting example, a stability and/or zeta potential of the colloidal food base composition may be controlled, selected, or tuned by the use of a selected technique (e.g. passive dehydration, drum drying, spray drying, etc.) for drying fungal biomass; without wishing to be bound by any particular theory, each of these drying techniques may result in a different viscosity of the colloidal food base composition and/or average size of particles of the dispersed phase in the colloidal food base composition, each of which may affect colloidal stability. By way of second non-limiting example, a stability and/or zeta potential of the colloidal food base composition may be controlled, selected, or tuned by forming the colloidal food base composition a selected length of time after growth of the fungal mycelial biomass, e.g., by aging the biomass or particles. By way of third non-limiting example, the morphology, structure, and/or degree of “entanglement” of a network of fungal filaments may be controlled, which may provide for greater ability of fungal filaments to stabilize particles of the dispersed phase within or at the surface of these filaments. By way of fourth non-limiting example, pretreatment of the fungal material (e.g., by heating and/or hydration) before incorporation into the colloidal food base composition may increase the viscosity of the dispersion medium and allow for proper water activity and/or other chemical “activation” of the fungal mycelial biomass, thereby producing a more stable colloid. By way of fifth non-limiting example, the distribution, diversity, and/or range of particle sizes of the fungal mycelial biomass may be controlled or selected to allow for higher or lower stability in some food products (e.g., without wishing to be bound by any particular theory, by stabilizing different sizes of particles of the dispersed phase). Thus, in the practice of the present disclosure, it is possible to provide filamentous fungal particles that naturally act as an emulsifier and/or stabilizer of the colloidal composition, which may in embodiments allow the quantity of other non-fungal-derived emulsifiers and/or stabilizers to be reduced or even eliminated, e.g. to less than about 3 wt %, less than about 2.5 wt %, less than about 2 wt %, less than about 1.5 wt %, less than about 1 wt %, less than about 0.75 wt %, less than about 0.5 wt %, less than about 0.4 wt %, less than about 0.3 wt %, less than about 0.2 wt %, or less than about 0.1 wt % of the colloidal food base composition; in some embodiments, the colloidal composition may be substantially free of non-fungal-derived emulsifiers, stabilizers, and/or surfactants. Further non-limiting examples of parameters that may be leveraged to control, select, or tune the stability and/or zeta potential of the colloidal food base composition include particle size distribution, surface area, morphology, porosity, surface energy, and fungal particle chemistry (e.g., protein content, relative abundance of amino acids, etc.). Some or all of these parameters may allow for the control, selection, or tuning of stability of colloidal food base compositions in which the dispersed phase is in any phase of matter (i.e., where the dispersed phase comprises solid particles, liquid droplets, and/or gas bubbles).

In embodiments of the present disclosure in which the colloidal food base composition includes one or more gases, a stability parameter of interest is foam stability, i.e., the proportion of an initial volume of a foam or solid foam that is retained by the foam or solid foam after a specified interval, to allow for the creation of a foam or solid foam that does not rapidly spontaneously collapse. The foaming process can include whipping with a whipping appliance, incorporation of compressed gases, or other conventional foaming processes, and will generally result in the formation of gas bubbles in a variety of sizes. The larger bubbles tend to pop after sitting or being poured, but smaller bubbles may remain in suspension for a long time to form a stable foam or solid foam product. A foam or solid foam material of the disclosure can have an increased volume (i.e., overrun) by incorporation of air of at least about 10%, at least about 20%, at least about 30%, at least about 40%, at least about 50%, at least about 75%, at least about 100%, at least about 200%, at least about 300%, at least about 400%, or at least about 500%, as compared to the starting volume of the liquid or solid dispersion medium prior to foaming. In various embodiments, a foam or solid foam of the disclosure may have a foam stability of at least about 50%, at least about 60%, at least about 70%, at least about 80%, at least about 90%, or at least about 95% for at least about 1 day, at least about 2 days, at least about 3 days, at least about 4 days, or at least about 5 days, at least about 6 days, at least about 7 days, at least about 8 days, at least about 9 days, at least about 10 days, at least about 11 days, at least about 12 days, at least about 13 days, at least about 14 days, or at least about 15 days, at least about 16 days, at least about 17 days, at least about 18 days, at least about 19 days, at least about 20 days, at least about 21 days, at least about 22 days, at least about 23 days, at least about 24 days, or at least about 25 days, at least about 26 days, at least about 27 days, at least about 28 days, at least about 29 days, or at least about 30 days. In some embodiments, the foam or solid foam may retain this stability for at least about one month, at least about two months, at least about three months, at least about four months, at least about five months, at least about six months, at least about seven months, at least about eight months, at least about nine months, at least about ten months, at least about eleven months, at least about twelve months, at least about thirteen months, at least about fourteen months, at least about fifteen months, at least about sixteen months, at least about seventeen months, or at least about eighteen months.

In embodiments of the present disclosure, it may be advantageous for the colloidal food base composition to be non-foaming, i.e., not to form a stable foam when aerated, whipped, etc. In these embodiments, any foam that may be formed when the colloidal food base composition is aerated, whipped, etc. using conventional home, commercial, or industrial kitchen equipment suitable for these purposes preferably collapse quickly (i.e., within seconds or minutes), and when formed may have an overrun of less than about 20%, less than about 15%, less than about 10%, less than about 5%, less than about 4%, less than about 3%, less than about 2%, or less than about 1%.

In some embodiments, the colloidal food composition may be a particle-stabilized colloid; such colloids in which both the dispersed phase and the dispersion medium are liquid are referred to as Pickering emulsions. In these embodiments, the fungal mycelial biomass may stabilize the colloid by adsorbing onto the interface between the dispersed phase and the dispersion medium.

Fungal mycelial biomass may be provided that has a desired hydrophilic-lipophilic balance (HLB) of between about 3 and about 16, in some embodiments between about 3 and about 6 (e.g., to stabilize a water-in-oil emulsion) or between about 8 and about 16 (e.g., to stabilize an oil-in-water emulsion).

Another important parameter related to the stability of colloidal food compositions according to the present disclosure is contact angle, i.e., the angle formed by two phase interfaces (generally between a liquid-gas interface, e.g., at the surface of a liquid droplet, and a liquid-solid interface, e.g., where a liquid droplet rests on a solid substrate). A low contact angle (e.g., close to 0°) demonstrates high surface energy, as the liquid droplet tends to spread across and adhere to the solid surface, whereas a high contact angle (e.g., close to 90°) demonstrates the solid surface's tendency to repel the liquid droplet. In embodiments of the present disclosure, the contact angle of the colloidal food composition on a solid surface such as a silicon wafer, at ambient conditions (e.g. about 25° C. and about 1 atm of pressure) may generally be between about 45° and about 75°; the surface energy, and thus the contact angle, of the colloidal food composition may, in some embodiments be controlled, selected, and/or tuned by use of different types of fungal mycelial biomass (e.g. particles produced by different techniques, such as spray drying vs. drum drying, or provided in different forms, such as homogenate vs. liquid dispersion of particles). Without wishing to be bound by any particular theory, it is believed that controlling, selecting, and/or tuning these and other similar parameters may allow for the formulation of colloidal food compositions having excellent stability, e.g., including fungal mycelial biomass having high water wettability (for highly stable oil-in-water emulsions), high oil wettability (for highly stable water-in-oil emulsions), and/or a balance between these two characteristics.

Particle-stabilized colloidal food compositions according to the present disclosure may particularly benefit from the use of relatively fine filamentous fungal particles, e.g. particles having a particle size of no more than about 120 microns, such as those that may be characterized as filamentous fungal “flours;” without wishing to be bound by any particular theory, it is believed that relatively finer or smaller particles of the filamentous fungus may more easily adsorb onto the interface between phases without causing collapse or rupture of the interface. Methods for preparing particle-stabilized colloidal food compositions are contemplated and are within the scope of the present disclosure.

The present disclosure may be particularly suitable for preparing analogs of typically high-fat conventional food products that have a lower content of total fats and/or specifically of saturated fats than analogous non-fungal food products. The nutritional advantages and benefits of providing low-fat and/or low-saturated-fat food products, and indulgence food products particularly, are well-known, and may further provide a commercial advantage, as health-conscious consumers may be more likely to purchase these food products. In some embodiments, colloidal compositions according to the present disclosure may comprise no more than about 600 mg, no more than about 450 mg, no more than about 300 mg, or no more than about 150 mg of saturated fat per 15 mL (1 tablespoon) of the colloidal composition.

In other embodiments, by contrast, the present disclosure may be particularly suitable for preparing analogs of typically high-fat conventional food products that have a comparable, or even higher, content of total fats and/or specifically of saturated fats than analogous non-fungal food products, as in some such foods the high fat content is an important content of the nutritional content, taste, texture, and/or culinary properties of the analogous non-fungal food product. By way of non-limiting example, the present disclosure may be particularly suitable for making analogs of (1) high-fat dairy products, e.g., half-and-half (10.5 to 18 wt % fat), light cream (18 to 30 wt % fat), whipping cream (30 to 36 wt % fat), heavy cream (at least about 36 wt % fat), and/or manufacturer's cream (at least about 40 wt % fat); (2) colloidal sauces and/or spreads with significant fat content, e.g., béchamel sauce, espagnole sauce, hollandaise sauce, alfredo sauce, hummus, Russian dressing, tartar sauce, Thousand Island dressing, velouté sauce, etc.; and/or (3) particularly fatty or otherwise decadent conventional colloidal food products, e.g. foie gras (typically about 44 wt % fat).

### Other Additives, Components, and Ingredients

As it is a primary object of the present disclosure to provide versatile colloidal food base compositions that can be used to make many different colloidal food products, the colloidal food base compositions may, in many embodiments, consist only or essentially of the fungal mycelial biomass, the aqueous liquid, and the one or more edible fats or oils; compositions of these kind will, in many applications, maximize the range, type, and amount of other food additives, components, and ingredients with which the colloidal food base composition may suitably be combined to create a diverse array of food products, and non-limiting examples of such other food components and ingredients are described in the paragraphs that follow. It is to be expressly understood, however, that in some applications and embodiments it may be desirable to include one or more additional components, as described throughout this disclosure, in the colloidal food base composition itself, by way of non-limiting example, colloidal food base compositions adapted specifically for use in confectionery may be made with included sugar or other sweeteners, colloidal food base compositions adapted specifically for baking may be made with included flours or leavening agents, and so on. The basic and novel characteristics of the colloidal food base compositions of the present disclosure include (i) that the composition is stable (i.e., does not separate into physically distinct phases, e.g., as determined by visual observation of the colloidal food base composition and any other food components or ingredients with which it may be combined or contacted) under storage and transportation conditions typical for food products, and (ii) that the composition is a base material from which multiple different food products can be made by the addition of other ingredients.

In some embodiments, the colloidal food base composition may comprise, be combined with, or be adapted or configured to be combined with one or more flavorings. Non-limiting examples of flavorings suitable for use with the food base compositions of the present disclosure include allyl hexanoate, benzyl acetate, bornyl acetate, butyl acetate, butyl butyrate, butyl propionate, ethyl acetate, ethyl benzoate, ethyl butyrate, ethyl hexanoate, ethyl cinnamate, ethyl formate, ethyl heptanoate, ethyl isovalerate, ethyl lactate, ethyl nonanoate, ethyl pentanoate, geranyl acetate, geranyl butyrate, geranyl pentanoate, isobutyl acetate, isobutyl formate, isoamyl acetate, isopropyl acetate, linalyl acetate, linalyl butyrate, linalyl formate, methyl acetate, methyl anthranilate, methyl benzoate, methyl butyrate, methyl cinnamate, methyl formate, methyl pentanoate, methyl phenylacetate, methyl salicylate, nonyl caprylate, octyl acetate, octyl butyrate, amyl acetate, pentyl butyrate, pentyl hexanoate, pentyl pentanoate, propyl acetate, propyl hexanoate, propyl isobutyrate, terpenyl butyrate, chocolate, cocoa, vanilla bean, vanilla extract, and vanilla paste.

The amount of any one flavoring, or any combination of flavorings, used in the disclosed compositions and methods can vary based on the desired texture and/or flavor of the final food product. In various aspects, an amount of 0.1 wt. %-25 wt. %, or any subrange thereof, of flavoring(s) can be used in the disclosed compositions and methods. In some embodiments, the amount of flavoring(s) used in the disclosed compositions and methods is selected from 0.1 wt. %, 0.2 wt. %, 0.3 wt. %, 0.4 wt. %, 0.5 wt. %, 0.6 wt. %, 0.7 wt. %, 0.8 wt. %, 0.9 wt. %, 1.0 wt. %, 1.1 wt. %, 1.2 wt. %, 1.3 wt. %, 1.4 wt. %, 1.5 wt. %, 2.0 wt. %, 2.5 wt. %, 3.0 wt. %, 3.5 wt. %, 4.0 wt. %, 4.5 wt. %, 5.0 wt. %, 5.5 wt. %, 6.0 wt. %, 6.5 wt. %, 7.0 wt. %, 7.5 wt. %, 8.0 wt. %, 8.5 wt. %, 9.0 wt. %, 9.5 wt. %, 10.0 wt. %, 10.5 wt. %, 11.0 wt. %, 11.5 wt. %, 12.0 wt. %, 12.5 wt. %, 13.0 wt. %, 13.5 wt. %, 14.0 wt. %, 14.5 wt. %, 15.0 wt. %, 15.5 wt. %, 16.0 wt. %, 16.5 wt. %, 17.0 wt. %, 17.5 wt. %, 18.0 wt. %, 18.5 wt. %, 19.0 wt. %, 19.5 wt. %, 20.0 wt. %, 20.5 wt. %, 21.0 wt. %, 21.5 wt. %, 22.0 wt. %, 22.5 wt. %, 23.0 wt. %, 23.5 wt. %, 24.0 wt. %, 24.5 wt. %, and 25.0 wt. %.

In some embodiments, the colloidal food base composition may comprise, be combined with, or be adapted or configured to be combined with one or more herbs. Non-limiting examples of herbs suitable for use with the food base compositions of the present disclosure include angelica, basil, bay leaf, Indian bay leaf, boldo, borage, chervil, chives, cicely, cilantro, cilantro, cress, curry leaf, dill, epazote, hemp, hoja santa, Houltuvnia cordata, hyssop, jimbu, Elsholtzia ciliata, Perilla frutescens, lavender, lemon balm, lemon grass, lemon myrtle, lemon verbena, rice paddy herb, lovage, marjoram, mint, mugwort, mitsuba, oregano, parsley, perilla, rosemary, rue, sage, savory, Zanthoxylum piperitum, shiso, sorrel, tarragon, thyme, and woodruff.

In some embodiments, the colloidal food base composition may comprise, be combined with, or be adapted or configured to be combined with one or more spices. Non-limiting examples of spices suitable for use with the food base compositions of the present disclosure include aonori, ajwain, alligator pepper, allspice, amchoor, anise, asafoetida, peppercorn, Brazilian pepper, camphor, caraway, cardamom, cassia, celery powder, celery seed, charoli, chenpi, chili pepper, cinnamon, clove, coriander seed, cubeb, cumin, deulkkae, dill, fennel, fenugreek, fingerroot, galangal, garlic, ginger, aromatic ginger, golpar, grains of paradise, grains of Selim, horseradish, Japanese pricklyash, juniper berry, kokum, korarima, dried lime, liquorice, Litsea cubeba, long pepper, mango-ginger, mastic, mahleb, mustard, nigella, njangsa, nutmeg, onion powder, paprika, Peruvian pepper, pomegranate seed, poppy seed, radhuni, rose, saffron, sarsaparilla, sassafras, sesame, shiso, Sichuan pepper, sumac, tamarind, Tasmanian pepper, tonka bean, turmeric, uzazi, vanilla, voatsiperifery, wasabi, zedoary, zereshk, and citrus fruit zest.

In some embodiments, the colloidal food base composition may comprise, be combined with, or be adapted or configured to be combined with one or more flavor enhancers. Non-limiting examples of flavor enhancers suitable for use with the food base compositions of the present disclosure include glutamic acid, monosodium glutamate, monopotassium glutamate, calcium diglutamate, monoammonium glutamate, magnesium diglutamate, guanylic acid, disodium guanylate, dipotassium guanylate, calcium guanylate, inosinic acid, disodium inosinate, dipotassium inosinate, calcium inosinate, calcium 5′-ribonucleotides, disodium 5′-ribonucleotides, maltol, ethyl maltol, glycine, sodium salt of glycine, zinc acetate, gum benzoic, thaumatin, glycyrrhizin, neohesperidine dihydrochalcone, amylase, and proteases.

In some embodiments, the colloidal food base composition may comprise, be combined with, or be adapted or configured to be combined with one or more preservatives. Non-limiting examples of preservatives suitable for use with the food base compositions of the present disclosure include rowanberry extract, sorbic acid, sodium sorbate, potassium sorbate, calcium sorbate, heptyl p-hydroxybenzoate, benzoic acid, sodium benzoate, potassium benzoate, calcium benzoate, ethylparaben, sodium ethyl para-hydroxybenzoate, propylparaben, sodium propyl para-hydroxybenzoate, methylparaben, sodium methyl para-hydroxybenzoate, sulfur dioxide, sodium sulfite, sodium bisulfite, sodium metabisulfite, potassium metabisulfite, potassium sulfite, calcium sulfite, calcium hydrogen sulfite, potassium hydrogen sulfite, biphenyl, orthophenyl phenol, sodium orthophenyl phenol, thiabendazole, nisin, natamycin, formic acid, sodium formate, calcium formate, hexamine, formaldehyde, dimethyl dicarbonate, potassium nitrite, sodium nitrite, sodium nitrate, potassium nitrate, acetic acid, potassium acetate, sodium acetates, calcium acetate, ammonium acetate, dehydroacetic acid, sodium dehydroacetate, lactic acid, propionic acid, sodium propionate, calcium propionate, potassium propionate, boric acid, sodium tetraborate, carbon dioxide, malic acid, fumaric acid, copper(II) sulfate, chlorine gas, chlorine dioxide, and lysozyme.

The amount of any one preservative, or any combination of preservatives, used in the disclosed compositions and methods can vary based on the desired shelf-life and taste of the final food product. In various aspects, an amount of 0.01 wt. %-3.0 wt. %, or any subrange thereof, of preservatives can be used in the disclosed compositions and methods. In some embodiments, the amount of a single preservative or of any combination of two or more preservatives used in the disclosed compositions and methods is selected from 0.05 wt. %, 0.1 wt. %, 0.15 wt. %, 0.2 wt. %, 0.25 wt. %, 0.3 wt. %, 0.35 wt. %, 0.4 wt. %, 0.45 wt. %, 0.5 wt. %, 0.55 wt. %, 0.6 wt. %, 0.65 wt. %, 0.7 wt. %, 0.75 wt. %, 0.8 wt. %, 0.85 wt. %, 0.9 wt. %, 0.95 wt. %, 1.0 wt. %, 1.1 wt. %, 1.2 wt. %, 1.3 wt. %, 1.4 wt. %, 1.5 wt. %, 1.6 wt. %, 1.7 wt. %, 1.8 wt. %, 1.9 wt. %, 2.0 wt. %, 2.1 wt. %, 2.2 wt. %, 2.3 wt. %, 2.4 wt. %, 2.5 wt. %, 2.6 wt. %, 2.7 wt. %, 2.8 wt. %, 2.9 wt. %, and 3.0 wt. %. In some embodiments, the colloidal food base composition may comprise, be combined with, or be adapted or configured to be combined with one or more sweeteners. Non-limiting examples of sweeteners suitable for use with the food base compositions of the present disclosure include sorbitol, mannitol, glycerol, acesulfame potassium, aspartame, cyclamate, isomalt, saccharin, sodium salts of saccharin, potassium salts of saccharin, calcium salts of saccharin, sucralose, alitame, thaumatin, glycyrrhizin, neohesperidine dihydrochalcone, steviol glycosides, neotame, aspartame-acesulfame salt, maltitol, lactitol, xylitol, erythritol, advantame, monk fruit sweetener (mogrosides), honey, coconut sugar, maple syrup, agave nectar, cane sugar, sucrose, fructose, and glucose.

The amount of any one sweetener, or any combination of sweeteners, used in the disclosed methods can vary based on the desired texture and/or flavor of the final food product. In various aspects, an amount of 1 wt. %-15 wt. %, or any subrange thereof, of sweetener(s) can be used in the disclosed compositions and methods. In some embodiments, the amount of sweetener(s) used in the disclosed compositions and methods is selected from 1.0 wt. %, 1.5 wt. %, 2.0 wt. %, 2.5 wt. %, 3.0 wt. %, 3.5 wt. %, 4.0 wt. %, 4.5 wt. %, 5.0 wt. %, 5.5 wt. %, 6.0 wt. %, 6.5 wt. %, 7.0 wt. %, 7.5 wt. %, 8.0 wt. %, 8.5 wt. %, 9.0 wt. %, 9.5 wt. %, 10.0 wt. %, 10.5 wt. %, 11.0 wt. %, 11.5 wt. %, 12.0 wt. %, 12.5 wt. %, 13.0 wt. %, 13.5 wt. %, 14.0 wt. %, 14.5 wt. %, and 15.0 wt. %.

In some embodiments, the colloidal food base composition may comprise, be combined with, or be adapted or configured to be combined with one or more color additives. Non-limiting examples of color additives suitable for use with the food base compositions of the present disclosure include curcumin, riboflavin, riboflavin-5′-phosphate, tartrazine, alkannin, Quinoline Yellow WS, Fast Yellow AB, riboflavin-5′-sodium phosphate, Yellow 2G, sunset yellow FCF, Orange GGN, carmine, carminic acid, Citrus Red 2, carmoisine, amaranth, Ponceau 4R, Scarlet GN, Ponceau 6R, erythrosine, Red 2G, Allura Red AC, indanthrone blue, Patent Blue V, indigo carmine, brilliant blue FCF, chlorophylls, chlorophyllins, copper complexes of chlorophylls and chlorophyllins, Green S, fast green FCF, plain caramel, caustic sulfite caramel, ammonia caramel, sulfite ammonia caramel, Brilliant Black BN, carbon black, vegetable carbon, Brown FK, Brown HT, carotenes, annatto, bixin, norbixin, paprika oleoresin, lycopene, beta-apo-8′-carotenal, ethyl ester of beta-apo-8′-carotenal, flavoxanthin, lutein, cryptoxanthin, rubixanthin, violaxanthin, rhodoxanthin, canthaxanthin, zeaxanthin, citranaxanthin, astaxanthin, betanin, anthocyanins, saffron, calcium carbonate, titanium dioxide, iron oxides, iron hydroxides, aluminum, silver, gold, Lithol Rubine BK, tannins, and orcein.

In some embodiments, the colloidal food base composition may comprise, be combined with, or be adapted or configured to be combined with one or more nutrients. Non-limiting examples of nutrients suitable for use with the food base compositions of the present disclosure include glucose, sucrose, ribose, amylose, amylopectin, maltose, galactose, fructose, lactose, alanine, arginine, aspartic acid, asparagine, cysteine, glutamic acid, glutamine, glycine, histidine, isoleucine, leucine, lysine, methionine, phenylalanine, proline, serine, threonine, tryptophan, tyrosine, valine, acetic acid, propionic acid, butyric acid, valeric acid, caproic acid, caprylic acid, lauric acid, myristic acid, pentadecanoic acid, palmitic acid, margaric acid, stearic acid, arachidic acid, behenic acid, lignoceric acid, cerotic acid, myristoleic acid, oleic acid, eicosenoic acid, erucic acid, nervonic acid, linoleic acid, alpha-linolenic acid, stearidonic acid, gamma-linolenic acid, arachidonic acid, eicosatetraenoic acid, timnodonic acid, clupanodonic acid, cervonic acid, calcium, sulfur, phosphorus, magnesium, sodium, potassium, iron, zinc, boron, copper, chromium, selenium, manganese, molybdenum, cobalt, fluorine, iodine, thiamin, riboflavin, niacin, pantothenic acid, pyridoxine, pyridoxal-5-phosphate, pyridoxamine, biotin, folate, cobalamin, choline, vitamin A, ascorbic acid, ergocalciferol, cholecalciferol, tocopherols, tocotrienols, phylloquinone, menaquinone, and menadione.

In some embodiments, the colloidal food base composition may comprise, be combined with, or be adapted or configured to be combined with one or more emulsifiers. Non-limiting examples of emulsifiers suitable for use with the food base compositions of the present disclosure include lecithin, metatartaric acid, calcium tartrate, alginic acid, sodium alginate, potassium alginate, ammonium alginate, calcium alginate, propane-1,2-diol alginate, carrageenan, processed Eucheuma seaweed, locust bean gum, tragacanth, acacia gum, karaya gum, gellan gum, gum ghatti, sorbitol, glycerol, konjac, polyoxyethene (8) stearate, polyoxyethene (40) stearate, polysorbate 20, polysorbate 80, polysorbate 40, polysorbate 60, polysorbate 65, pectins, gelatine, ammonium phosphatides, brominated vegetable oil, sucrose acetate isobutyrate, glycerol esters of wood rosins, diphosphates, triphosphates, polyphosphates, beta-cyclodextrin, cellulose, methyl cellulose, ethyl cellulose, hydroxypropyl cellulose, Hypromellose, ethyl methyl cellulose, carboxymethyl cellulose, sodium carboxymethyl cellulose, croscarmellose, enzymically hydrolyzed carboxymethylcellulose, sodium salts of fatty acids, potassium salts of fatty acids, calcium salts of fatty acids, magnesium salts of fatty acids, mono- and diglycerides of fatty acids, acetic acid esters of mono- and diglycerides of fatty acids, lactic acid esters of mono- and diglycerides of fatty acids, citric acid esters of mono- and diglycerides of fatty acids, tartaric acid esters of mono- and diglycerides of fatty acids, mono- and diacetyl tartaric acid esters of mono- and diglycerides of fatty acids, mixed acetic and tartaric acid esters of mono- and diglycerides of fatty acids, succinylated monoglycerides, sucrose esters of fatty acids, sucroglycerides, polyglycerol esters of fatty acids, polyglycerol polyricinoleate, propane-1,2-diol esters of fatty acids, propylene glycol esters of fatty acids, lactylated fatty acid esters of glycerol and propane-1, thermally oxidized soybean oil interacted with mono- and diglycerides of fatty acids, dioctyl sodium sulfosuccinate, sodium stearoyl-2-lactylate, calcium stearoyl-2-lactylate, stearyl tartrate, stearyl citrate, sodium stearoyl fumarate, calcium stearoyl fumarate, sodium laurylsulfate, ethoxylated mono- and diglycerides, methyl glucoside-coconut oil ester, sorbitan monostearate, sorbitan tristearate, sorbitan monolaurate, sorbitan monooleate, sorbitan monopalmitate, sorbitan trioleate, dicalcium diphosphate, sodium aluminum phosphate, calcium sodium polyphosphate, calcium polyphosphate, ammonium polyphosphate, magnesium stearate, calcium stearate, cholic acid, choline salts, oxidized starch, distarch glycerol, acetylated distarch phosphate, hydroxy propyl starch, starch sodium octenyl succinate, and acetylated oxidized starch.

In some embodiments, the colloidal food base composition may comprise, be combined with, or be adapted or configured to be combined with one or more stabilizers or thickeners. Non-limiting examples of stabilizers or thickeners suitable for use with the food base compositions of the present disclosure include oxystearin, alginic acid, sodium alginate, potassium alginate, ammonium alginate, calcium alginate, propane-1,2-diol alginate, agar, carrageenan, processed Eucheuma seaweed, locust bean gum, oat gum, guar gum, tragacanth, acacia gum, xanthan gum, karaya gum, tara gum, gellan gum, gum ghatti, polyoxyethene (8) stearate, aspartame-acesulfame salt, maltitol, amylase, proteases, invertase, polydextrose, polyvinylpyrrolidone, polyvinylpolypyrrolidone, dextrin, modified starch, alkaline modified starch, bleached starch, monostarch phosphate, distarch phosphate esterified with sodium trimetaphosphate or phosphorus oxychloride, phosphated distarch phosphate, starch acetate esterified with acetic anhydride, starch acetate acetified with vinyl acetate, acetylated distarch adipate, distarch glycerine, hydroxy propyl distarch glycerine, hydroxy propyl distarch phosphate, starch sodium octenyl succinate, triethyl citrate, oxidized starch, distarch glycerol, acetylated distarch phosphate, acetylated distarch glycerol, hydroxy propyl starch, citrus fiber, guar-xanthan blends, and hydroxyethyl cellulose.

The amount of any one stabilizer and/or thickener, or any combination of stabilizers and/or thickeners, used in the disclosed compositions and methods can vary based on the desired texture and/or taste of the final food product. In various aspects, an amount of 0.01 wt. %-3.0 wt. %, or any subrange thereof, of stabilizer and/or thickener can be used in the disclosed compositions and methods. In some embodiments, the amount of a single stabilizer and/or thickener, or combination of two or more stabilizers and/or thickeners, used in the disclosed compositions and methods is selected from 0.05 wt. %, 0.1 wt. %, 0.15 wt. %, 0.2 wt. %, 0.25 wt. %, 0.3 wt. %, 0.35 wt. %, 0.4 wt. %, 0.45 wt. %, 0.5 wt. %, 0.55 wt. %, 0.6 wt. %, 0.65 wt. %, 0.7 wt. %, 0.75 wt. %, 0.8 wt. %, 0.85 wt. %, 0.9 wt. %, 0.95 wt. %, 1.0 wt. %, 1.1 wt. %, 1.2 wt. %, 1.3 wt. %, 1.4 wt. %, 1.5 wt. %, 1.6 wt. %, 1.7 wt. %, 1.8 wt. %, 1.9 wt. %, 2.0 wt. %, 2.1 wt. %, 2.2 wt. %, 2.3 wt. %, 2.4 wt. %, 2.5 wt. %, 2.6 wt. %, 2.7 wt. %, 2.8 wt. %, 2.9 wt. %, and 3.0 wt. %.

In some embodiments, the colloidal food base composition may comprise, be combined with, or be adapted or configured to be combined with one or more pH control agents. Non-limiting examples of pH control agents suitable for use with the food base compositions of the present disclosure include acetic acid, potassium acetate, sodium acetates, calcium acetate, carbon dioxide, malic acid, fumaric acid, sodium lactate, potassium lactate, calcium lactate, ammonium lactate, magnesium lactate, citric acid, sodium citrates, potassium citrates, calcium citrates, sodium tartrates, potassium tartrates, sodium potassium tartrate, lecithin citrate, magnesium citrate, ammonium malate, sodium malates, potassium malate, calcium malates, adipic acid, sodium adipate, potassium adipate, ammonium adipate, succinic acid, monosodium fumarate, potassium fumarate, calcium fumarate, ammonium fumarate, 1,4-heptonolactone, niacin, triammonium citrate, ammonium ferric citrate, calcium glycerylphosphate, isopropyl citrate, sodium carbonates, potassium carbonates, ammonium carbonates, magnesium carbonates, ferrous carbonate, ammonium chloride, ammonium sulfate, magnesium sulfate, aluminum potassium sulfate, aluminum ammonium sulfate, sodium hydroxide, potassium hydroxide, calcium hydroxide, ammonium hydroxide, magnesium hydroxide, calcium oxide, magnesium oxide, sodium ferrocyanide, dicalcium diphosphate, gluconic acid, and glucono delta-lactone.

In some embodiments, the colloidal food base composition may comprise, be combined with, or be adapted or configured to be combined with one or more acidulants. Non-limiting examples of acidulants suitable for use with the food base compositions of the present disclosure include acetic acid, ascorbic acid, citric acid, fumaric acid, lactic acid, malic acid, phosphoric acid, and tartaric acid.

In some embodiments, the colloidal food base composition may comprise, be combined with, or be adapted or configured to be combined with one or more leavening agents. Non-limiting examples of leavening agents suitable for use with the food base compositions of the present disclosure include Saccharomyces cerevisiae, monocalcium phosphates, sodium aluminum sulfate, disodium pyrophosphate, sodium aluminum phosphates, and sodium carbonates.

In some embodiments, the colloidal food base composition may comprise, be combined with, or be adapted or configured to be combined with one or more anti-caking agents. Non-limiting examples of anti-caking agents suitable for use with the food base compositions of the present disclosure include calcium phosphates, magnesium phosphates, mannitol, sodium salts of fatty acids, potassium salts of fatty acids, calcium salts of fatty acids, magnesium salts of fatty acids, magnesium carbonates, magnesium oxide, sodium ferrocyanide, potassium ferrocyanide, ferrous hexacyanomanganate, calcium ferrocyanide, bone phosphate, sodium silicates, silicon dioxide, calcium silicate, magnesium silicates, talc, sodium aluminosilicate, potassium aluminum silicate, calcium aluminosilicate, zinc silicate, bentonite, aluminum silicate, potassium silicate, fatty acids, magnesium stearate, calcium stearate, and dimethyl polysiloxane.

In some embodiments, the colloidal food base composition may comprise, be combined with, or be adapted or configured to be combined with one or more humectants. Non-limiting examples of humectants suitable for use with the food base compositions of the present disclosure include sorbitol, maltitol, polydextrose, triacetin, and propylene glycol.

In some embodiments, the colloidal food base composition may comprise, be combined with, or be adapted or configured to be combined with one or more yeast nutrients. Non-limiting examples of yeast nutrients suitable for use with the food base compositions of the present disclosure include ammonium chloride, ammonium sulfate, ammonium phosphate, phosphoric acid, and calcium iodate.

In some embodiments, the colloidal food base composition may comprise, be combined with, or be adapted or configured to be combined with one or more dough strengtheners or dough conditioners. Non-limiting examples of dough strengtheners or dough conditioners suitable for use with the food base compositions of the present disclosure include ammonium chloride, calcium oxide, L-cysteine, L-cystine, potassium persulfate, ammonium persulfate, potassium bromate, calcium bromate, chlorine gas, azodicarbonamide, urea, benzoyl peroxide, and calcium peroxide.

In some embodiments, the colloidal food base composition may comprise, be combined with, or be adapted or configured to be combined with one or more firming agents. Non-limiting examples of firming agents suitable for use with the food base compositions of the present disclosure include calcium gluconate, calcium hydrogen sulfite, calcium citrates, calcium phosphates, calcium chloride, magnesium chloride, magnesium sulfate, aluminum sulfate, aluminum sodium sulfate, and calcium hydroxide.

In some embodiments, the colloidal food base composition may comprise, be combined with, or be adapted or configured to be combined with one or more vegetables or vegetable protein isolates. Non-limiting examples of vegetables suitable for use with (and/or suitable for the isolation of proteins that may be used with) the food base compositions of the present disclosure include soybean, cabbage, Brussels sprouts, cauliflower, broccoli, kale, kohlrabi, red cabbage, Savoy cabbage, Chinese broccoli, collard greens, turnip, Chinese cabbage, napa cabbage, bok choy, radish, daikon, carrot, parsnip, beetroot, sea beet, Swiss chard, sugar beet, lettuce, celtuce, green bean, French bean, runner bean, haricot bean, Lima bean, broad bean, pea, snap pea, snow pea, split pea, potato, eggplant, tomato, cucumber, pumpkin, squash, marrow, zucchini, gourd, onion, spring onion, scallion, shallot, garlic, leek, elephant garlic, pepper, bell pepper, sweet pepper, spinach, yam, sweet potato, and cassava.

In some embodiments, the colloidal food base composition may comprise, be combined with, or be adapted or configured to be combined with one or more fruits. Non-limiting examples of fruits suitable for use with the food base compositions of the present disclosure include apple, apricot, banana, blackberry, blackcurrant, blueberry, boysenberry, cantaloupe, cherry, cranberry, fig, gooseberry, grape, grapefruit, guava, kiwifruit, lemon, lime, lucuma, mulberry, orange, Osage orange, pawpaw, peach, pear, pineapple, plum, pomegranate, raspberry, redcurrant, rose hip, strawberry, and watermelon.

In some embodiments, the colloidal food base composition may comprise, be combined with, or be adapted or configured to be combined with one or more meat products. Non-limiting examples of meat products suitable for use with the food base compositions of the present disclosure include pork, beef, mutton, veal, poultry, chevon, venison, chicken, duck, rabbit, goose, and turkey.

In some embodiments, the colloidal food base composition may comprise, be combined with, or be adapted or configured to be combined with one or more probiotics. Non-limiting examples of probiotics suitable for use with the food base compositions of the present disclosure include probiotic strains of bacteria in the genera Lactobacillus and Bifidobacteriun.

In some embodiments, the colloidal food base composition may be formulated such that one or more alcohols (e.g., sugar alcohol sweeteners; ethanol, where the colloidal food base composition is intended to allow for the creation of “Jello shot”-type colloidal alcoholic beverages; and so on) is miscible with, or soluble, freely soluble, or very soluble in, the colloidal food base composition. Additionally or alternatively, the colloidal food base composition may be formulated such that one or more plant milks (almond milk, coconut milk, oat milk, pea milk, soy milk, etc.) is miscible with, or soluble, freely soluble, or very soluble in, the colloidal food base composition.

### Gases/Foams

Many applications of the colloidal food base compositions of the present disclosure may call for a colloidal food base composition that comprises one or more colloidally dispersed culinary gases, i.e., a multiple colloidal system in which the emulsion, gel, or sol formed by the fungal mycelial biomass, aqueous liquid, and one or more edible oils or fats (or one or more phases thereof) forms a dispersion medium of a foam comprising the one or more culinary gases. Inclusion of these culinary gases may be undertaken for any one or more of many rationales. By way of first non-limiting example, inclusion of a culinary gas to form a foam may provide a desired texture and/or taste to the colloidal food base composition. By way of second non-limiting example, the culinary gas may be a biocidal gas and thus act to sterilize the colloidal food base composition or otherwise minimize biological contamination or degradation (i.e., may as a preservative). By way of third non-limiting example, the culinary gas may minimize oxidation or other forms of chemical degradation during packaging, shipping, and/or storage of the colloidal food base composition. By way of fourth non-limiting example, the culinary gas may pressurize the colloidal food base composition or otherwise act as a propellant to expel the colloidal food base composition from a pressurized container, e.g., via a trigger nozzle or similar applicator. By way of fifth non-limiting example, a culinary gas may be used as a cryogenic preservative, i.e., the colloidal food base composition may be manufactured at cryogenic temperatures and include a liquefied culinary gas (e.g., nitrogen gas or carbon dioxide) that extends the shelf life of the colloidal food base composition by providing a very high degree of control over bacterial activity within the colloidal food base composition.

In some embodiments, the colloidal food base composition may include carbon dioxide. Particularly, carbon dioxide may be suitable to cool the colloidal food base composition or in other cryogenic processes and/or adjust the taste and/or texture of the colloidal food base composition. It may also be used to “pre-carbonate” beverages or other food products made using the colloidal food base composition or protect other ingredients in the colloidal food base composition (e.g., the fungal mycelial biomass, meat or fish ingredients, etc.) from oxidation and discoloration. Carbon dioxide is also an effective antibacterial agent and can thus be included as an edible preservative.

In some embodiments, the colloidal food base composition may include oxygen gas. Particularly, colloidal food base compositions that include fruit or vegetable ingredients may benefit from the inclusion of oxygen gas to preserve the vivid colors of these ingredients or otherwise maintain their freshness during manufacture, packaging, shipping, and/or storage. Oxygen gas can, moreover, prevent anaerobic degradation/fermentation of the colloidal food base composition.

In some embodiments, the colloidal food base composition may include nitrogen gas. Particularly, nitrogen gas may be an effective propellant or pressurizing agent, and/or to rapidly cool or freeze the colloidal food base composition during manufacture, packaging, shipping, and/or storage. Nitrogen gas is also effective to prevent oxidation and thus act as an antimicrobial preservative.

In some embodiments, the colloidal food base composition may include hydrogen gas. Particularly, hydrogen gas can improve the shelf life of colloidal food base compositions, and its addition can cause certain vegetable oils to solidify or semi-solidify, which may be desirable in certain applications. Hydrogen gas can also undergo certain chemical reactions in silts within the colloidal food base composition which may be desirable, e.g., eliminating carbon-carbon double bonds in organic molecules and thus converting unsaturated fats to saturated fats.

In some embodiments, the colloidal food base composition may include argon. Particularly, argon inhibits respiratory enzymes in both fungi and bacteria and thus may help to preserve the flavor of the colloidal food base composition during manufacture, packaging, shipping, and/or storage. Argon also inhibits the oxidation of fats and the growth of damaging anaerobes, and may even protect the colloidal food base composition against packaging collapse.

In some embodiments, the colloidal food base composition may include helium. Particularly, helium may be included as a quality control agent for packaging (e.g., to detect holes in food-grade seals meant to be gas-impermeable).

It is to be expressly understood that a wide variety of other gases that may be less commonly used in food products may suitably be included in colloidal food base compositions of the present disclosure, so long as they are safe for consumption in food in the amounts provided. Such gases include, by way of non-limiting example, food-grade propellants such as nitrous oxide, butane, isobutane, and propane.

### Methods of Manufacture and Use

Generally, manufacturing colloidal food base compositions according to the present disclosure can be as simple as a single step: contacting all of the components, i.e., the fungal mycelial biomass, the aqueous liquid, and the one or more edible fats or oils, in such a way as to form a stable emulsion, gel, or sol. Often, this can be achieved by merely mixing the components in a single vessel, whether by hand or using a household, commercial, or industrial mixer/blender.

The components of the colloidal food base composition may generally be added in any order in the contacting step, and the contacting step may thus include any number of substeps of addition and/or combination of components. By way of first non-limiting example, the fungal mycelial biomass and the aqueous liquid may first be added to a vessel (simultaneously or sequentially in either order) and mixed, blended, or otherwise combined to form a substantially homogeneous dispersion of the fungal mycelial biomass in the aqueous liquid, whereupon the one or more edible fats or oils may then be added to the vessel (simultaneously or sequentially in any order) and mixed, blended, or otherwise combined with the aqueous fungal dispersion to form the colloidal food base composition. By way of second non-limiting example, the fungal mycelial biomass and the one or more edible fats and/or oils may first be added to a vessel (simultaneously or sequentially in any order) and mixed, blended, or otherwise combined to form a substantially homogeneous mixture of the fungal mycelial biomass in the edible fats/oils, whereupon the aqueous liquid may then be added to the vessel and mixed, blended, or otherwise combined with the substantially homogeneous mixture to form the colloidal food base composition. By way of third non-limiting example, the aqueous liquid and the one or more edible fats and/or oils may first be added to a vessel (simultaneously or sequentially in any order) and mixed, blended, or otherwise combined to form a fat-in-water sol, an oil-in-water emulsion, a water-in-fat gel, a water-in-oil emulsion, or a colloid that may be characterized as a combination of these types, whereupon the fungal mycelial biomass may then be added to the vessel and mixed, blended, or otherwise combined with this colloid to form the colloidal food base composition. By way of fourth non-limiting example, the fungal mycelial biomass, the aqueous liquid, and the one or more edible fats and/or oils may be added to a vessel (simultaneously or sequentially in any order), and all three components may be mixed, blended, or otherwise combined together to form the colloidal food base composition in a single procedure. It is to be expressly understood that any one or more of the fungal mycelial biomass, the aqueous liquid, and the one or more edible fats and/or oils may be added in multiple aliquots, any one of which may be added either before or while a mixing, blending, etc. substep is being performed.

Most commonly, the contacting step is carried out at room/ambient temperature, but it is to be expressly understood that in many embodiments, it may instead be carried out at temperatures significantly lower or higher than room/ambient temperature. Where the contacting step comprises multiple substeps of addition and/or combination of components, any one or more of these substeps may be carried out at room temperature, below room temperature, or above room temperature, and any preceding or following substep may be carried out at the same temperature or a lower or higher temperature.

While smaller quantities of colloidal food base composition can be prepared by hand (e.g., by mixing the components together with a spoon, whisk, eggbeater, or hand mixer), commercially or industrially relevant quantities will typically require a larger and/or more powerful device. Non-limiting examples of devices/methods that may be employed for the contacting step of methods of the present disclosure include spiral stand mixers, planetary stand mixers, dough mixers, blenders, high-shear mixers, high-viscosity mixers, static mixers, and vortex mixers.

In some embodiments, it may be desirable to carry out the contacting step under reduced pressure, such as a medium vacuum pressure (i.e., from about 100 mPa to about 3 kPa), a high vacuum pressure (i.e., from about 100 nPa to about 100 mPa), an ultra-high vacuum pressure (i.e., from about 100 pPa to about 100 nPa), or an extremely high vacuum pressure (i.e., less than about 100 pPa). A reduced-pressure environment for carrying out the contacting step may be desirable to reduce the oxidation rate of fats/oils in the colloidal food base composition and/or mitigate the growth of aerobic pathogens in or on the colloidal food base composition, among other potential features that may be desirable for certain applications.

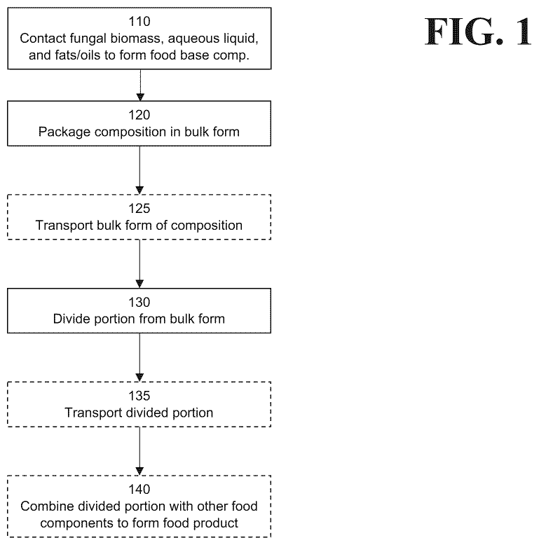

Referring now to FIG. 1, a method 100 for making a food product is illustrated. The method 100 illustrated in FIG. 1 includes at least a contacting step 110, a packaging step 120, a dividing step 130, and a combining step 140, and may optionally include one or more transporting steps 125, 135.

In the contacting step 110 of the method 100 illustrated in FIG. 1, a colloidal food base composition is prepared according to the considerations outlined in the preceding paragraphs.

In the packaging step 120, the colloidal food base composition is packaged for transportation and/or short- or long-term storage in a bulk form, i.e., in an amount greater than is generally called upon for use at a single time. Most generally, the packaging step 120 comprises any technique for placing the colloidal food base composition in a (preferably recloseable or resealable) container that protects the colloidal food base composition and extends its usable life by reducing the colloidal food base composition's exposure to at least one of light, oxygen, temperature fluctuations, and biological and/or chemical contamination. Non-limiting examples of suitable containers for use in the packaging step 120 include aseptic packaging, trays, bags, cans, cartons, and/or flexible polymeric and/or biopolymeric packaging, in some embodiments, these containers may, as part of the packaging step 120, then be packaged in secondary, tertiary, etc. containers, such as boxes, pallets, wrappers, and the like.

The amount of colloidal food base composition and/or of the final food product can be provided in aseptic packaging of different weights and volumes based on the desired application. In various aspects, the packaging may contain a volume of about 0.15 liters (0.04 gallons) to about 12 liters (3.17 gallons), or any subrange thereof, of the colloidal food base composition and/or of the final food product. In some embodiments, the internal volume of the packaging, or the volume of the colloidal food base composition and/or final food product contained therein, is selected from about 0.15 liters (0.04 gallons), about 0.2 liters (0.05 gallons), about 0.25 liters (0.07 gallons), about 0.3 liters (0.08 gallons), about 0.35 liters (0.09 gallons), about 0.4 liters (0.11 gallons), about 0.45 liters (0.12 gallons), about 0.5 liters (0.13 gallons), about 0.6 liters (0.16 gallons), about 0.7 liters (0.18 gallons), about 0.8 liters (0.21 gallons), about 0.9 liters (0.24 gallons), about 1 liter (0.26 gallons), about 1.2 liters (0.32 gallons), about 1.4 liters (0.37 gallons), about 1.6 liters (0.42 gallons), about 1.8 liters (0.48 gallons), about 2 liters (0.53 gallons), about 2.2 liters (0.58 gallons), about 2.4 liters (0.63 gallons), about 2.6 liters (0.69 gallons), about 2.8 liters (0.74 gallons), about 3 liters (0.79 gallons), about 3.5 liters (0.92 gallons), about 4 liters (1.06 gallons), about 4.5 liters (1.19 gallons), about 5 liters (1.32 gallons), about 6 liters (1.59 gallons), about 7 liters (1.85 gallons), about 8 liters (2.11 gallons), about 9 liters (2.38 gallons), about 10 liters (2.64 gallons), about 11 liters (2.91 gallons), and about 12 liters (3.17 gallons). In various aspects, the packaging may contain a weight of about 0.15 kg (0.33 pounds) to about 12 kg (26.46 pounds), or any subrange thereof, of the colloidal food base composition and/or of the final food product. In some embodiments, the weight of the colloidal food base composition and/or of the final food product in the packaging is selected from about 0.15 kg (0.33 pounds), about 0.2 kg (0.44 pounds), about 0.25 kg (0.55 pounds), about 0.3 kg (0.66 pounds), about 0.35 kg (0.77 pounds), about 0.4 kg (0.88 pounds), about 0.45 kg (0.99 pounds), about 0.5 kg (1.1 pounds), about 0.6 kg (1.32 pounds), about 0.7 kg (1.54 pounds), about 0.8 kg (1.76 pounds), about 0.9 kg (1.98 pounds), about 1 kg (2.2 pounds), about 1.2 kg (2.65 pounds), about 1.4 kg (3.09 pounds), about 1.6 kg (3.53 pounds), about 1.8 kg (3.97 pounds), about 2 kg (4.41 pounds), about 2.2 kg (4.85 pounds), about 2.4 kg (5.29 pounds), about 2.6 kg (5.73 pounds), about 2.8 kg (6.17 pounds), about 3 kg (6.61 pounds), about 3.5 kg (7.72 pounds), about 4 kg (8.82 pounds), about 4.5 kg (9.92 pounds), about 5 kg (11.02 pounds), about 6 kg (13.23 pounds), about 7 kg (15.43 pounds), about 8 kg (17.64 pounds), about 9 kg (19.84 pounds), about 10 kg (22.05 pounds), about 11 kg (24.25 pounds), and about 12 kg (26.46 pounds).

In the dividing step 130, a portion of the bulk form of the colloidal food base composition is divided from the bulk form for subsequent use in the combining step 140; it is this divided portion that is ultimately present in the finished food product. The dividing step 130 may take any suitable form, which those skilled in the art may readily comprehend, but the primary consideration is the mechanical behavior of the colloidal food base composition; for example, when the colloidal food base composition is more “liquid-like” (i.e., flows without taking on a fixed shape when a stress is applied), as is generally the case when the colloidal food base composition is an emulsion or sol, a portion of the colloidal food base composition may be divided from the bulk form by pouring, dispensing via a pump or nozzle, etc., whereas when the colloidal food base composition is more “solid-like” (i.e., generally has a fixed shape and does not flow, but may deform, when a stress is applied), as is generally the case when the colloidal food base composition is a gel, a portion of the colloidal food base composition may be divided from the bulk form by cutting, chopping, dicing, mincing, grinding, blending, sonicating, etc. In some embodiments, the packaging step 120 may include packaging the bulk form of the colloidal food base composition in a pressurized container (e.g., an aerosol can or similar), in which case the dividing step 130 may include operating a nozzle, trigger, etc. of the pressurized container to force the portion of the colloidal food base composition out of the container and onto a work surface, into a cooking vessel, or the like.

In the combining step 140, the divided portion of the colloidal food base composition is combined with one or more other food components to form a food product. The identity of the one or more other food components and the food product are essentially unconstrained, with non-limiting examples of each being provided elsewhere throughout this disclosure. The combination of the divided portion of the colloidal food base composition with the one or more other food components may be carried out by mixing, blending, stirring, or any other suitable technique for combining two or more food ingredients.

Optionally, the bulk form of the colloidal food base composition may be transported 125 to another location prior to the dividing step 130, and/or the divided portion of the colloidal food base composition may be transported 135 to another location prior to the combining step 140. Stated slightly differently, a location where the contacting and packaging steps 110, 120 are carried out may be the same as or different from a location where the dividing step 130 is carried out, which may in turn be the same as or different from a location where the combining step 140 is carried out; by way of non-limiting example, the contacting and packaging steps 110, 120 may be carried out in a centralized manufacturing and packing facility, the dividing step 130 may be carried out in a warehouse or distribution center, and the combining step 140 may be carried out in a commercial kitchen or other food service location.

During optional transporting steps 125, 135, and/or during time intervals between any two or more consecutive steps, storage conditions, and especially storage temperature and pressure, for the colloidal food base composition may be selected to ensure maximal shelf life, minimization of biological or chemical contamination, etc. By way of first non-limiting example, the colloidal food base composition, by virtue of its chemical composition and/or the container in which it is packaged in packaging step 120, may remain stable (e.g., not separate) and have a suitably long shelf life even under ambient conditions; in these embodiments, it is not necessary to refrigerate, or otherwise carefully control the environment of, the bulk form and/or the divided portion during storage or transportation, and the bulk form and/or the divided portion can therefore be stored or transported at room temperature. By way of second non-limiting example, the colloidal food base composition, by virtue of its chemical composition and/or intended use (e.g., in a refrigerated beverage, a frozen dessert product, etc.), may be most usefully maintained, and/or may exhibit a desirably high degree of stability (e.g., not separate), at refrigerator, freezer, or cryogenic temperatures (e.g., temperatures of less than about 4° C., or in the case of refrigeration between about 0° C. and about 4° C., and in some embodiments at least as low as about −50° C.); in these embodiments, the bulk form and/or the divided portion may be stored or transported under refrigeration, freezing, or cryogenic conditions. By way of third non-limiting example, the colloidal food base composition, by virtue of its chemical composition and/or intended use, may be most usefully maintained, and/or may exhibit a desirably high degree of stability (e.g., not separate), at elevated temperatures, such as those used in baking, boiling, frying, or other types of cooking (e.g., temperatures of more than about 35° C. and in some embodiment at least as high as about 100° C.). By way of fourth non-limiting example, it may be desirable for the colloidal food base composition to be kept under pressures lower or higher than ambient pressure; in these embodiments, the bulk form and/or the divided portion may be stored or transported in a low-pressure environment (e.g., in a vacuum chamber of a container ship, truck, warehouse, etc.) or in a high-pressure environment (e.g., in a tanker truck, pressurized pipeline, etc.).

The following examples are provided for the purpose of illustration only. They depict specific embodiments and are not intended to limit the scope or breadth of the present disclosure.

### EXAMPLES

### Example 1: A Colloidal Emulsion Food Base Composition Containing Fungal Mycelium

A colloidal emulsion food base composition suitable as a non-dairy culinary cream substitute was prepared from spray dried flour of edible filamentous fungal biomass, i.e., spray dried biomass obtained by a submerged fermentation process, derived from the filamentous acidophilic fungus Fusarium strain flavolapis (ATCC Accession Deposit No. PTA-10698). Fungal mycelium biomass was grown via a stirred-tank submerged fermentation process followed by inactivation of growth of the biomass. The mycelium was then washed with deionized water and the washed biomass having a water content of about 75-85 wt. % was collected and spray dried to produce a fungal mycelium flour.

The resulting flour was used in the following colloidal emulsion food base composition recipe as shown in Table 1.

TABLE 1

Batch size (g): 4000.00

| Ingredient | Percent | Quantity (g) |
|---|---|---|
| Fungal Mycelium Flour | 5.00% | 200.00 |
| Water | 71.87% | 2874.80 |
| Coconut Fat | 5.00% | 200.00 |
| Avocado Oil | 15.00% | 600.00 |
| Sucrose | 1.65% | 66.00 |
| Guar-Xanthan Blend - | 0.55% | 22.00 |
| CPKelco Kelgum 87 | | |
| Salt | 0.11% | 4.40 |
| Rowanberry Extract | 0.5200% | 20.80 |
| Canola Lecithin - ADM | 0.3000% | 12.00 |
| Yelkin | | |
| Total | 100.00% | 4000.00 |

The hydrocolloids were hydrated in the water for four minutes in a large Vitamix blender. The hydrocolloid/water mixture was blended two times at setting 4, scrapping down the sides once half-way through. The fungal mycelium flour and the remaining dry ingredients were added to the blender and blended for 2 minutes at setting 4, scraping the sides after mixing Next, the fat was added to the blender and mixed for 2 minutes at setting 4 scraping the sides afterwards. The resulting mixture was then homogenized with one pass at 172/30 bar (i.e. 2000 PSI) followed by pasteurization in a Thermomix for 35 minutes at 160° F. and stir speed 4. The resulting pasteurized, warm colloidal emulsion food base composition was placed into a plastic container and stored in a walk-in cooler.

### Example 2: Alfredo Sauce with a Fungal Colloidal Food Base Composition

An alfredo sauce was prepared that contained the following ingredients as shown in Table Table 2

TABLE 2

| Ingredient | Quantity (g) | Percentage |
|---|---|---|
| Grapeseed oil | 14.68 | 2.94% |
| Yellow onion, finely chopped | 77.06 | 15.41% |
| Garlic, minced | 13.21 | 2.64% |
| Colloidal food base | 330.28 | 66.06% |
| composition from Example 1 | | |
| Nutritional yeast | 29.14 | 5.83% |
| Roasted garlic | 24.95 | 1.47% |
| Salt, Kosher | 3.34 | 4.99% |
| Lemon juice, fresh | 7.34 | 0.67% |
| TOTAL | 500 g | 100% |

Oil was preheated in a skillet over medium heat for 1 minute. The onions were added and sauteed until softened (about 6 minutes). The garlic was added, and the mixture continued to cook until fragrant (about 1 more minute).

In a separate sauce pot, the colloidal food base composition of Example 1 was heated to a gentle simmer. The sauteed onion and garlic mixture was transferred to a Vitamix blender followed by the warmed colloidal food base composition. Nutritional yeast, roasted garlic, and salt were added.

The mixture was blended until smooth, about 1 minute, scraping down sides of the blender as needed. Lemon juice was then added and stirred to combine. The resulting sauce showed no signs of separation and was combined with warm pasta and served.

### Example 3—Chocolate Pudding with a Fungal Colloidal Food Base Composition

A chocolate pudding was prepared that contained the following ingredients as shown in Table 3.

TABLE 3

| Ingredient | Quantity (g) | Percentage |
|---|---|---|
| Colloidal food base | 331.22 | 66.22% |
| composition of Example 1 | | |
| Granulated sugar | 64.55 | 12.91% |
| Dark chocolate (70%) | 102.93 | 20.59% |
| Vanilla bean paste | 0.78 | 0.16% |
| Salt, Kosher | 0.63 | 0.13% |
| TOTAL | 500 g | 100% |

The colloidal food base composition of Example 1 was warmed and combined with sugar until the sugar was completely dissolved. The resulting mixture was transferred to a Vitamix Blender. Chocolate, vanilla, and salt were added. The mixture was blended on low speed until the chocolate was broken up and melted (about 15 seconds). The speed was then increased to high and the mixture was blended for 2 minutes. The resulting pudding was transferred to an air-tight container and refrigerated overnight to set.

### Example 4a—Testing of Commercial Culinary Creams and Cream Substitutes

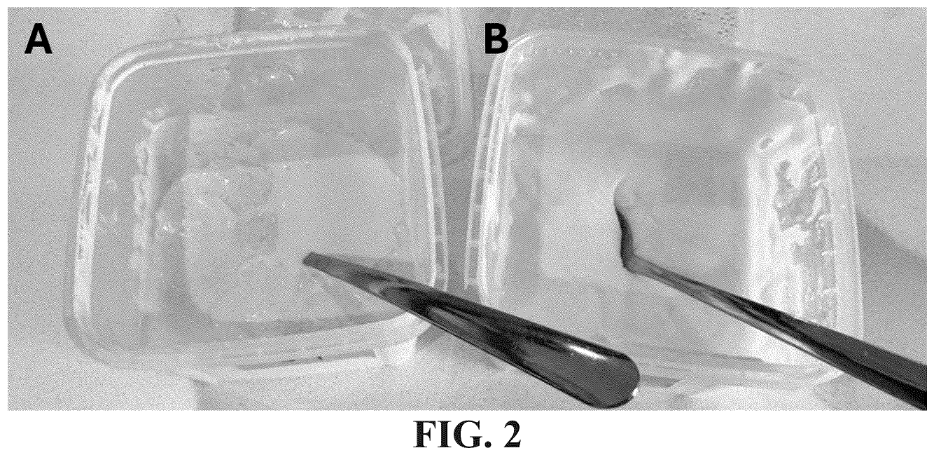

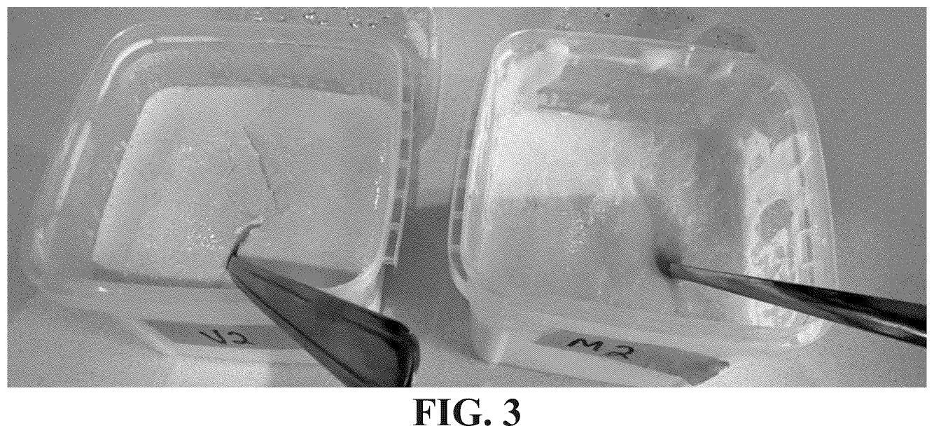

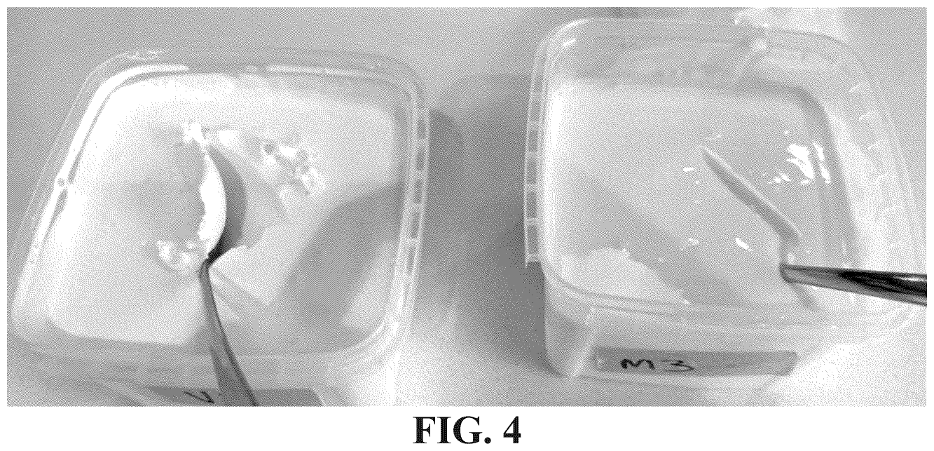

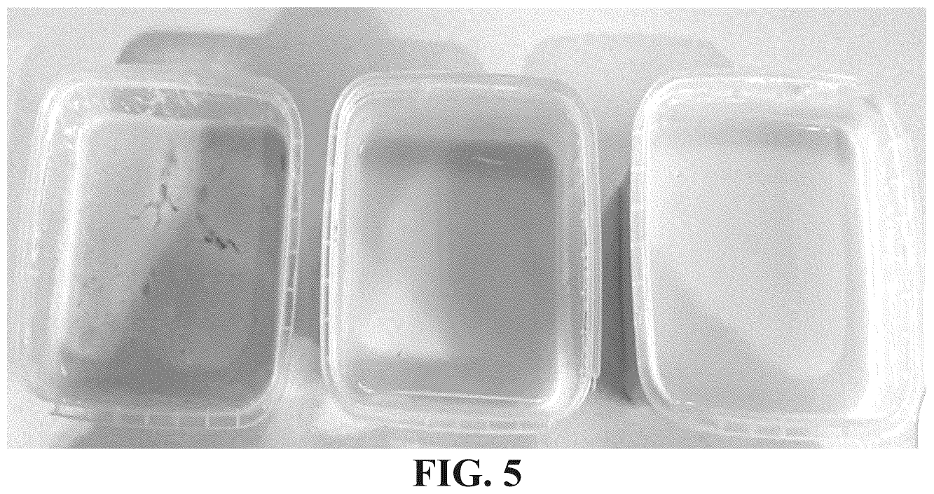

Comparative testing was performed on the following three commercial products: Product 1-Violife 100% Vegan® Just Like Heavy Whipping Cream cream alternative (pH 6.6, 3 g saturated fat, and 45 calories per 1 Tbsp; dairy free; contains guar gum, locust bean gum, and sunflower lecithin); Product 2—Rich's® Culinary Solutions® Plant Based Cooking Creme, (pH 7.5, 35 calories per 1 Tbsp; dairy free; contains sunflower lecithin, cellulose gum, and xanthan gum); and Product 3—Nestle Minor's® Culinary Cream® (pH 4.8, 2 g saturated fat, and 30 calories per 1 Tbsp; dairy based; contains guar gum and xanthan gum). Each product was subjected to the following conditions:
1. Heated and cooled, no acid
   a) Heated
   b) Heated and then Cooled
2. Heated and cooled w/ acid
   a) Heated
   b) Heated and then Cooled
3. Cooled w/ acid
Acidifying—added white distilled vinegar to each sample until pH 3.5 was reached (prior to heat step if heated)
Heating—brought samples to a boil (212° F.) then dropped to a simmer (about 175° F.) for 10 minutes.
Cooling—sample was cooled in refrigerator to 39.
   The following observations were recorded for each:

| Product | Condition 1a | Condition 1b | Condition 2a | Condition 2b | Condition 3 |
|---|---|---|---|---|---|
| 1 | visible fat separation | fat that separated during | fat separation but | thickened, very | extremely thick requires |
| | film around edges of pot | simmering left a yellow | minimal compared | smooth, consistency | force to scoop |
| | sample turns a | film on top | to 1a | of greek yogurt | no yellowing |
| | yellowish color | slightly thicker than | film forms on pot but | yellow film on top | See FIG. 4 (composition |
| | | control | not as thick as 1a | See FIG. 3 (composition | on the left). |
| | | See FIG. 2A | sample turned a | on the left). | |
| | | (composition on the | yellowish color | | |
| | | left, labeled “A”). | | | |
| 2 | even simmering | darkest in color | frothy on surface, | very separated after | separated |
| | throughout liquid- not | broken layer on surface | lighter in color than 1a | cooling (hard to know | thinner viscosity than |
| | just edges of pot | mucusy/slimy | reduced significantly | if it's just vinegar that | control |
| | started foaming once | consistency | over the course of | separated or if it's | lightest in color |
| | it came to a boil | viscous but flowable | simmer time | rich's as well) | See FIG. 5 (composition |
| | thickens significantly, | See FIG. 5 (composition | thin film around | thinner viscosity | on the right). |
| | even prior to cooling | on the left). | edges of pot | See FIG. 5 (composition | |
| | thick film around | | | in the middle). | |
| | edges of pot | | | | |
| | darkened in color | | | | |
| 3 | large bubbles mostly | substantially thicker, | not as thick and | syneresis around edges | more set than control- |
| | around edges while | not pourable; only | jiggly since it's | set up/coagulated- | spoon leaves trail in |
| | simmering | spoonable | been thinned out | when you tilt container | sample and does not |
| | no extreme fat separation | See FIG. 2 | with vinegar | sample pulls away | reclose |
| | but can see small fat | (composition on the | no separation | from sides | See FIG. 4 (composition |
| | droplets on surface | right, labeled “B”). | | See FIG. 3 (composition | on the right). |
| | still thick and jiggly | | | on the right) | |
| | even when at a | | | | |
| | boil/simmer | | | | |

Overall, Product 1 easily broke (fat separated) when heated. Adding acid in any state drastically changed the texture. Product 2 frothed when heated (both with and without addition of acid). A component in Product 2 caramelized during heating, as both heated samples turned darker in color. Addition of acid caused separation, although it was unclear if the separation was the vinegar separating or a component of the Product 2 product. Product 3 remained jiggly in all states, even during heating. Heating and adding acid caused it to set slightly.

### Example 4b—Testing of Fungal Non-Dairy Culinary Cream Substitute

A colloidal emulsion food base non-dairy culinary cream substitute was prepared from spray dried flour of edible filamentous fungal biomass, i.e., spray dried biomass obtained by a submerged fermentation process, derived from the filamentous acidophilic fungus Fusarium strain flavolapis (ATCC Accession Deposit No. PTA-10698). Fungal mycelium biomass was grown via a stirred-tank submerged fermentation process followed by inactivation of the biomass. The mycelium was then washed with deionized water and the washed biomass having a water content of about 75-85 wt. % was collected and spray dried to produce a fungal mycelium flour. The resulting flour was used in the following colloidal emulsion food base non-dairy culinary cream substitute recipe as shown in Table 4 below.

TABLE 4

| Ingredient | % |
|---|---|
| Fungal Biomass Flour | 5.00% |
| Water | 71.67% |
| Avocado Oil | 20.00% |
| Sucrose | 1.65% |
| Guar-Xanthan Blend (CPKelco Kelgum 87) | 0.55% |
| Citrus Fiber (Herbacel AQ Citri-N) | 0.50% |
| Salt | 0.11% |
| Rowanberry Extract | 0.52% |
| TOTAL | 100% |

The fungal non-dairy culinary cream substitute (pH 6.07, 450 mg protein, 300 mg fiber, 450 mg saturated fat, and 30 calories per 1 Tbsp) and a 3:1 dilution (3 parts fungal non-dairy culinary cream substitute mixed with 1 part water) were subjected to the following conditions:
1. Heated and cooled, no acid
   a) Heated
   b) Heated and Cooled
2. Heated and cooled w f acid
   a) Heated
   b) Heated and Cooled
3. Cooled w/acid

### Methods

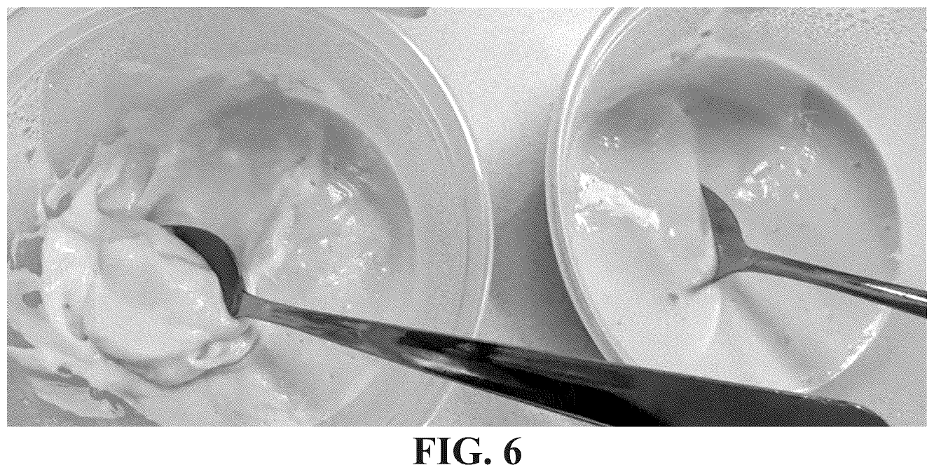

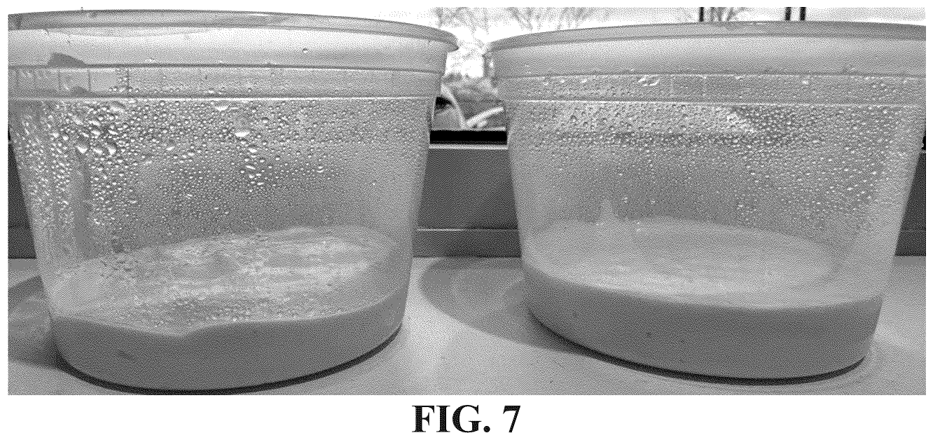

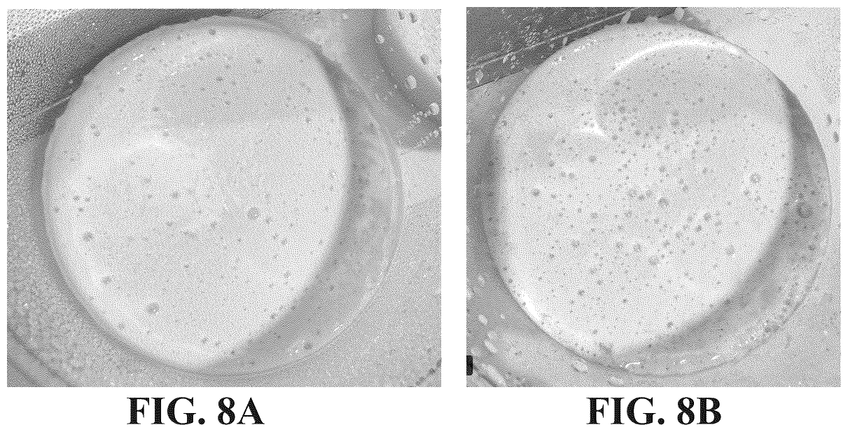

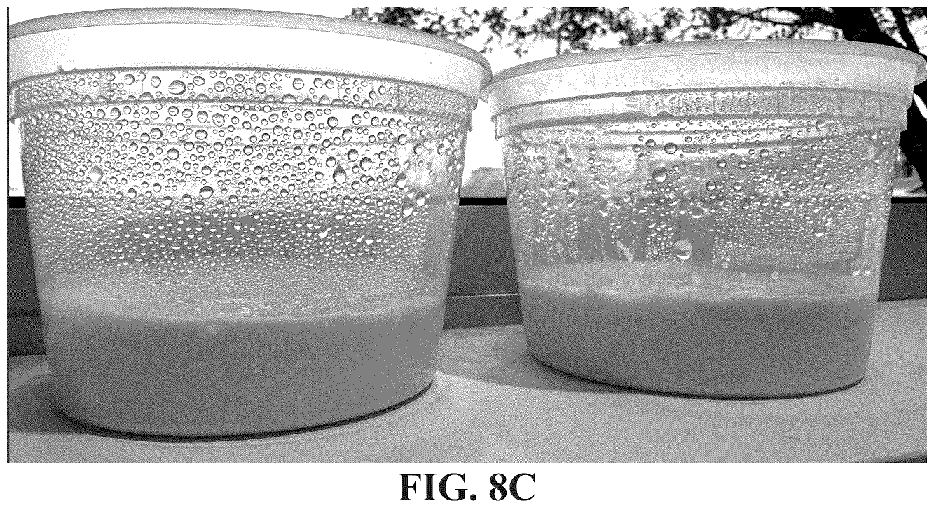

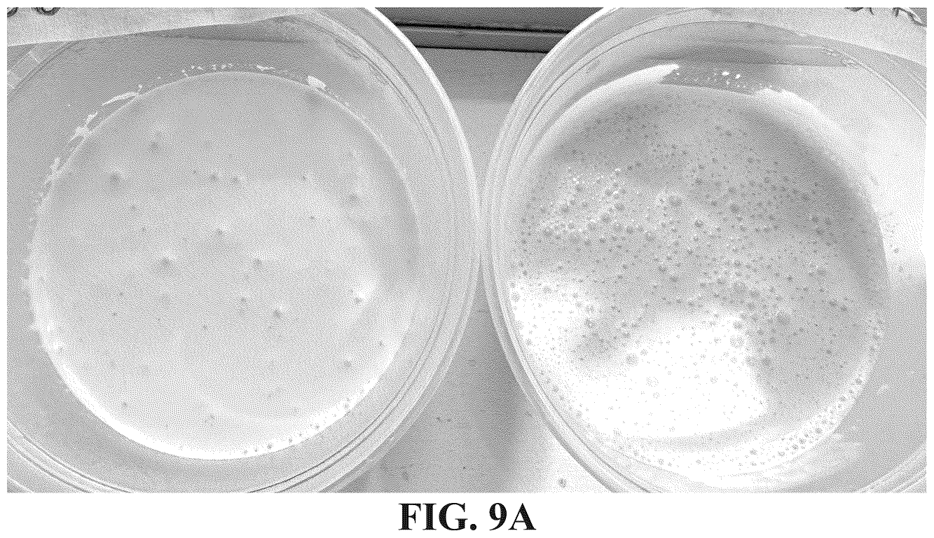

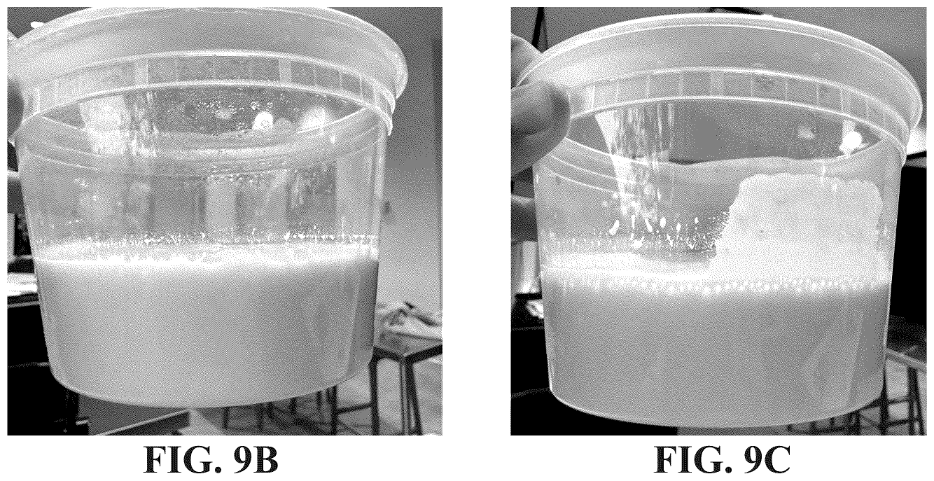

Acidifying—53 g (¼ cup) lemon juice+140 g (¾ cup) sample to bring pH to 3.36.
Heating—brought samples to a boil (212° F.) then dropped to a simmer (about 175° F.) for 10 minutes.
Cooling—sample was cooled in refrigerator.
   The following observations were recorded:

| | 1a | 1b | 2a | 2b | 3 |
|---|---|---|---|---|---|
| Undiluted | thickened a moderate | any clumps that were | less of a film around | a slight sheen | no separation or |
| fungal base | amount from water | formed from film | edges since the Base | on surface but | curdling |
| emulsion | evaporation- film also | around edges/after | was diluted with | no separation | See FIGS. 9B and |
| | forms on surface due | whisking and chilling | lemon juice | no curdling | the composition on |
| | to moisture loss | are no longer visible | See FIG. 8A and | bubbles on | the left in FIG. 9A. |
| | a film formed around | no off flavors | the composition on | surface | |
| | edges but when | extra thick and | the left in FIG. 8C. | | |
| | whisked, the clumps | scoop-able texture. | | | |
| | went away. | no separation or | | | |
| | large slow bubbles | color changes | | | |
| | during simmering | See FIG. 7 | | | |
| | See FIG. 6 (composition | (composition | | | |
| | on the left). | on the left). | | | |
| Fungal base | thin film formed around | hollandaise-like | hardly any film | a slight sheen | bubbles on surface |
| emulsion- | edges- when edges were | viscosity, thickened | formed on edges | on surface but | no separation or |
| 3:1 dilution | scraped, the film formed | slightly from original | since the Base was | wouldn't | curdling |
| | small clumps that could | 3:1 dilution. | diluted 3:1 with | consider it | See FIG. 9C and |
| | be whisked back in | no separation or | added lemon juice | separated | the composition on |
| | continuous slow | color changes | See FIG. 8B and | bubbles on | the right in |
| | simmer. | no off flavors | the composition on | surface | FIG. 9A. |
| | See FIG. 6 (composition | See FIG. 7 | the right in FIG. 8C. | | |
| | on the right). | (composition | | | |
| | | on the right). | | | |

Overall, the fungal non-dairy culinary cream substitute (both undiluted and diluted) was heat and acid stable. A slight sheen was observed under the heat with acid condition, but no separation was observed. The only major change in the fungal base products during any of the test conditions was the thickening of undiluted fungal base when simmered for 10 minutes.

### Example 5—Whiteness of Fungal Non-Dairy Culinary Cream Substitute

Two batches of fungal non-dairy culinary cream substitute were prepared as detailed in Example 4b and color was measured with a ColorFlex® Spectrocolorimeter (Hunter Associates Laboratory, Reston, VA). Briefly, the colorimeter was calibrated using color plate standards after which the fungal non-dairy culinary cream substitute was poured into a glass sample cup to a previously marked level, covered, and color was measured. The following L*, a*, and b* color values were obtained:

TABLE 5

| | L* | a* | b* |
|---|---|---|---|
| Batch 1 | 83.40 | 0.22 | 14.07 |
| Batch 2 | 84.57 | 0.08 | 13.01 |

The concepts illustratively disclosed herein suitably may be practiced in the absence of any element which is not specifically disclosed herein. It is apparent to those skilled in the art, however, that many changes, variations, modifications, other uses, and applications of the disclosure are possible, and changes, variations, modifications, other uses, and applications which do not depart from the spirit and scope of the disclosure are deemed to be covered by the disclosure.

The foregoing discussion has been presented for purposes of illustration and description. The foregoing is not intended to limit the disclosure to the form or forms disclosed herein. In the foregoing Detailed Description, for example, various features are grouped together in one or more embodiments for the purpose of streamlining the disclosure. The features of the embodiments may be combined in alternate embodiments other than those discussed above. This method of disclosure is not to be interpreted as reflecting an intention that the claims require more features than are expressly recited in each claim. Rather, as the following claims reflect, inventive aspects lie in less than all features of a single foregoing disclosed embodiment. Thus, the following claims are hereby incorporated into this Detailed Description, with each claim standing on its own as a separate embodiment.

Moreover, though the present disclosure has included description of one or more embodiments and certain variations and modifications, other variations, combinations, and modifications are within the scope of the disclosure, e.g., as may be within the skill and knowledge of those in the art, after understanding the present disclosure. It is intended to obtain rights which include alternative embodiments to the extent permitted, including alternate, interchangeable, and/or equivalent structures, functions, ranges, or steps to those claimed, regardless of whether such alternate, interchangeable, and/or equivalent structures, functions, ranges, or steps are disclosed herein, and without intending to publicly dedicate any patentable subject matter.

1. A food base composition, comprising:
fungal mycelial biomass, wherein a dry weight of the fungal mycelial biomass is about 2 wt % to about 15 wt % of the food base composition;
an aqueous liquid, in an amount of about 20 wt % to about 80 wt %; and
one or more edible fats or oils, in an amount of about 10 wt % to about 80 wt %.

2. The food base composition of claim 1, wherein at least one of the following is true:
(i) the food base composition comprises no more than about 450 mg of saturated fat per 15 mL (1 tablespoon) of the food base composition;
(ii) the food base composition comprises at least about 150 mg of protein per 15 mL (1 tablespoon) of the food base composition;
(iii) the food base composition comprises at least about 150 mg of dietary fiber per 15 mL (1 tablespoon) of the food base composition; and
(iv) the food base composition has a food energy content of no more than about 35 kcal per 15 mL (1 tablespoon) of the food base composition.

3. The food base composition of claim 2, wherein the food base composition has an L* color value of at least about 70.

4. The food base composition of claim 2, wherein a pH of the food base composition is about 5.5 to about 6.5.

5. The food base composition of claim 2, wherein the fungal mycelial biomass does not comprise fungal fruiting bodies or portions thereof.

6. The food base composition of claim 2, wherein the fungal mycelial biomass comprises at least about 30 wt % protein.

7. The food base composition of claim 2, wherein the fungal mycelial biomass is of a filamentous fungus belonging to a genus selected from the group consisting of Fusarium, Aspergillus, Trichoderma, Rhizopus, Rhizomucor, Ustilago, Hericululm, Polyporous, Grifola, Hypsizygus, Calocybe, Pholiota, Calvatia, Stropharia, Agaricus, Hypholoma, Pleurotus, Morchella, Sparassis, Disciotis, Cordyceps, Ganoderma, Flammulina, Lentinula, Ophiocordyceps, Trametes, Ceriporia, Leucoagaricus, Handkea, Monascus and Neurospora.

8. The food base composition of claim 2, wherein the food base composition comprises between about 1 wt % to about 10 wt % protein.

9. The food base composition of claim 2, wherein the food base composition is non-dairy.

10. The food base composition of claim 2, wherein the food base composition is vegan.

11. The food base composition of claim 2, wherein the food base composition is configured such that the aqueous liquid and the one or more edible fats or oils can remain substantially homogenously mixed, and/or do not visibly separate, when subjected to an acidic condition, a heat condition, a cold condition, or combinations thereof.

12. The food base composition of claim 11, wherein the acidic condition is a pH of 6.5 or lower, the heat condition is a temperature of 35° C. or higher, and the cold condition is a temperature of 4° C. or lower.

13. A method for making a food product, comprising:
contacting a food base composition with at least one food component, wherein the food base composition comprises fungal mycelial biomass, an aqueous liquid, and one or more edible fats or oils and is in the form an emulsion, gel, or sol; and
subjecting the contacted food base composition and food component to an acidic condition, a heat condition, a cold condition, or combinations thereof,
wherein the food base composition does not separate into an aqueous phase and an edible fat or oil phase during the contacting step or the subjecting step.

14. The method of claim 13, wherein the subjecting step comprises acidifying the contacted food base composition and food component.

15. The method of claim 14, wherein the subjecting step comprises acidifying the contacted food base composition and food component to a pH of 6.5 or lower.

16. The method of claim 13, wherein the subjecting step comprises heating the contacted food base composition and food component.

17. The method of claim 16, wherein the subjecting step comprises heating the contacted food base composition and food component to a temperature of 35° C. or higher.

18. The method of claim 13, wherein the subjecting step comprises cooling the contacted food base composition and food component.

19. The method of claim 18, wherein the subjecting step comprises cooling the contacted food base composition and food component to a temperature of 4° C. or lower.

20. The method of claim 13, wherein the subjecting step comprises acidifying the contacted food base composition and food component to a pH of 6.5 or lower and heating the contacted food base composition and food component to a temperature of 35° C. or higher.

21. The method of claim 13, wherein the food base composition comprises:
fungal mycelial biomass, in an amount of about 2 wt % to about 15 wt %;
an aqueous liquid in an amount of about 20 wt % to about 80 wt %; and
one or more edible fats or oils, in an amount of about 10 wt % to about 80 wt %.

22. The method of claim 21, wherein the food base composition is non-dairy.

23. The method of claim 21, wherein the food product is non-dairy.

24. The method of claim 21, wherein the food base composition is vegan.

25. The method of claim 21, wherein the food product is vegan.

26. The method of claim 21, wherein the contacted food base composition and food component does not form a stable foam during the contacting step.

27. The method of claim 26, wherein the contacted food base composition and food component has an overrun of less than about 20%.

28. The method of claim 21, wherein the food product is selected from a butter analog, a margarine analog, a mayonnaise analog, a milk analog, a half-and-half analog, a light cream analog, a whipping cream analog, a heavy cream analog, a manufacturer's cream analog, a béchamel sauce analog, an espagnole sauce analog, a hollandaise sauce analog, an alfredo sauce analog, a hummus analog, a Russian dressing analog, a tartar sauce analog, a Thousand Island dressing analog, a velouté sauce analog, a foie gras analog, a gelatin analog, a marmalade analog, a jam analog, a jelly analog, and a dessert pudding analog.

29. The method of claim 21, wherein the fungal mycelial biomass comprises proteins having an isoelectric point of 6.0 or less.

30. The method of claim 21, wherein the contacting step comprises mixing the contacted food base composition and the food component.
